(19) United States
(12) Patent Application Publication
(10) Pub. No.: US 2016/0121596 A1
(43) Pub. Date: May 5, 2016

(54) LITHOGRAPHIC PRINTING PLATE PRECURSOR, AND METHOD FOR PRODUCING SAME

(71) Applicant: FUJIFILM Corporation, Tokyo (JP)

(72) Inventor: Ryo SAITO, Haibara-gun (JP)

(73) Assignee: FUJIFILM Corporation, Tokyo (JP)

(21) Appl. No.: 14/994,265

(22) Filed: Jan. 13, 2016

Related U.S. Application Data
(63) Continuation of application No. PCT/JP2014/066440, filed on Jun. 20, 2014.

(30) Foreign Application Priority Data
Jul. 18, 2013 (JP) 2013-149862

(51) Int. Cl. B41C 1/10

(52) U.S. Cl. CPC B41C 1/10

(57) ABSTRACT

Provided is a lithographic printing plate precursor having extremely excellent and excellent on-board developability even after the lithographic printing plate precursor is preserved for a long period of time, and excellent preservation stability, by a lithographic printing plate precursor including, on a support, an image recording layer containing (A) a thermoplastic fine particle polymer, (B) an infrared ray absorbing dye, and (C) a polyglycerol compound, in which the infrared ray absorbing dye is an infrared ray absorbing dye expressed by the Formula (I) as defined herein, and the polyglycerol compound is a compound having three or more structural units selected from structural units expressed by the Formulae (1) and (2) as defined herein.

### CROSS REFERENCE TO RELATED APPLICATION

This is a continuation of International Application No. PCT/JP2014/066440 filed on Jun. 20, 2014, and claims priority from Japanese Patent Application No. 2013-149862 filed on Jul. 18, 2013, the entire disclosures of which are incorporated herein by reference.

### BACKGROUND OF THE INVENTION

1. Field of the Invention

The present invention relates to a lithographic printing plate precursor and a method for producing the same. Particularly, a lithographic printing plate precursor that can perform image recording and on-board development using various lasers based on digital signals and a method for producing the same.

2. Description of the Related Art

The lithographic printing plate includes a lipophilic image portion that stores ink in a printing process and a hydrophilic non-image portion that stores dampening water. The lithographic printing uses characteristics in which water and oil ink are repellent to each other, causing a lipophilic image portion of a lithographic printing plate and a hydrophilic non-image portion respectively as an ink storing portion and a dampening water storing portion (ink non-storing portion), to cause difference of adhesiveness of ink on the surface of the lithographic printing plate, inking only an image portion, transferring ink to a printing target medium such as paper, and perform printing.

In the related art, a lithographic printing plate is obtained by performing image exposure through a mask such as a lithographic film on the lithographic printing plate precursor by using lithographic printing plate precursor (PS plate) having a lipophilic photosensitive resin layer (image recording layer, image forming layer) on a hydrophilic support, performing a development process using an alkaline developer or the like, leaving an image recording layer corresponding to the image portion, and dissolving and removing an unnecessary image recording layer corresponding to a non-image portion.

A plate producing step of producing a lithographic printing plate from a lithographic printing plate precursor is simplified. Therefore, recently, with respect to the image exposure, the lithographic printing plate can be obtained by a computer-to-plate (CTP) technique. That is, a lithographic printing plate can be obtained by using a laser or a laser diode, without interposing a lithographic film therebetween, directly scanning and exposing a lithographic printing plate precursor, and performing a development process.

Recently, in the plate producing step of a lithographic printing plate precursor, there is suggested a method called on-board development of removing a non-image portion on a printing machine, after image exposure by using an image recording layer of which an unnecessary portion of a lithographic printing plate precursor can be removed in a normal printing step and obtaining a lithographic printing plate. According to this method, a lithographic printing plate can be obtained by removing a non-image portion by using at least one of printing ink and dampening water on the printing machine after image exposure by causing a highly convergent radiant ray such as laser light to carry the digitalized image information and scanning and exposing the lithographic printing plate precursor, in response to a digitalizing technique of electronically processing image information by a computer and accumulating and outputting the image information. Accordingly, a development process step of lithographic printing plate, which is a necessary step in a printing industry in the related art, can be omitted, and thus a plate producing operation can be performed in a completely dry environment (liquid is not used), such that it is possible to greatly reduce the load of operations and environments.

The lithographic printing plate precursor which is suitable for on-board development is a lithographic printing plate precursor (hereinafter, referred to as an on-board development-type lithographic printing plate precursor) that has an image recording layer of which a non-image portion can be removed by any one of printing ink and dampening water on the printing machine.

As the on-board development-type lithographic printing plate precursor, a lithographic printing plate precursor (for example, JP2002-287334A) that has an image recording layer containing an infrared ray absorption agent, a polymerization initiator, and a polymerizable compound on a support and a lithographic printing plate precursor (for example, JP2938397B) that has an image recording layer containing an infrared ray absorption agent and thermoplastic polymer particles on a support are known.

In general, as a prestep of installing a lithographic printing plate on a printing machine, an operation (plate inspection) inspecting and discriminating an image on a lithographic printing plate to know whether image recording is performed on a lithographic printing plate as intended is performed. With respect to a normal lithographic printing plate precursor accompanied by a course of a development process, generally, if an image recording layer is colored, a colored image can be obtained by a development process, and thus it is easy to check an image before a printing plate is installed on a printing machine.

However, in an on-board development-type lithographic printing plate precursor that does not perform a development process, it is difficult to check an image on a lithographic printing plate precursor in a step in which a lithographic printing plate precursor is installed on a printing machine, and thus plate inspection cannot be performed sufficiently. Particularly, whether it is possible to determine that a dot (register mark) which becomes a sign of registration in multicolor printing is drawn is important in a printing operation. Therefore, in the on-board development-type lithographic printing plate precursor, means for checking an image in an image-exposing step, that is, a so-called printout image in which an exposed portion is colored or achromatized, is required to be formed.

As means for forming a printout image, various suggestions have made, but none of them are sufficient for forming a visible image having a high contrast which is required for plate inspection. JP2008-544322A discloses a thermosensitive image forming element containing an IR dye having a specific structure that can form a printout image with an infrared ray or heat, and discloses that the thermosensitive image forming element containing the IR dye having this specific structure can form a visible image having a high contrast after image exposure.

However, it is acknowledged that on-board developability of the thermosensitive image forming element containing the IR dye having the specific structure remarkably decreases over time. That is, the thermosensitive image forming element disclosed in JP2008-544322A has excellent visibility (plate inspection properties) but has a problem in that on-board developability after preservation is deteriorated.

Accordingly, it is desired to provide a thermal fusion-type lithographic printing plate precursor having excellent visibility and excellent on-board developability over time.

### SUMMARY OF THE INVENTION

An object of the invention is to provide a thermal fusion-type lithographic printing plate precursor having excellent visibility and excellent on-board developability even after the lithographic printing plate precursor is preserved for a long period of time. Another object of the invention is to provide a thermal fusion-type lithographic printing plate precursor having excellent preservation stability.

The object of the invention can be achieved by a lithographic printing plate precursor and a method for producing the same, described below.

(1) A lithographic printing plate precursor including, on a support, an image recording layer containing (A) a thermoplastic fine particle polymer, (B) an infrared ray absorbing dye, and (C) a polyglycerol compound, in which the infrared ray absorbing dye is an infrared ray absorbing dye expressed by General Formula (I) below, and the polyglycerol compound is a compound having three or more structural units selected from structural units expressed by General Formulae (1) and (2) below,

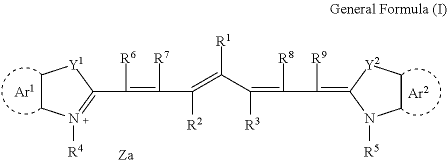

where, in General Formula (I), R¹ represents a group expressed by General Formula (Ia) below, each of R² and R³ independently represents a hydrogen atom or an alkyl group, or R² and R³ represent atomic groups that are required for forming a cyclic structure by being linked to each other, each of Ar¹ and Ar² independently represents an atomic group that is required for forming a benzene ring or a naphthalene ring, each of Y¹ and Y² independently represents an sulfur atom or a dialkyl methylene group, each of R⁴ and R⁵ independently represents an alkyl group, each of R⁶, R⁷, R⁸, and R⁹ independently represents a hydrogen atom or an alkyl group, and Za represents a counter ion that neutralizes electrical charges,

—NR¹⁰-L-X—Y General Formula (Ia)

where, in General Formula (Ia), R¹⁰ represents a hydrogen atom, an aliphatic hydrocarbon group, or a (hetero)aryl group, or an atomic group that is required for forming a cyclic structure by being linked to Y, L represents a single bond or a bivalent linking group, X represents —CO—, —SO₂—, or —SO—, Y represents —R^{11a}, —OR^{11b}, —NR¹²R¹³, or —CF₃, R^{11a} represents a hydrogen atom, an aliphatic hydrocarbon group, or a (hetero)aryl group, R^{11b} represents an aliphatic hydrocarbon group or a (hetero)aryl group, each of R¹² and R¹³ independently represents a hydrogen atom, an aliphatic hydrocarbon group, or a (hetero)aryl group, or R¹² and R¹³ represent atomic groups that are required for forming a cyclic structure by being linked to each other, and

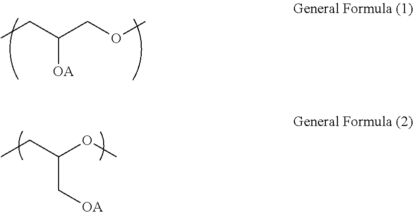

where, in General Formulae (1) and (2), A represents a hydrogen atom, an alkyl group having 1 to 4 carbon atoms, or an alkyl carbonyl group having 2 to 5 carbon atoms.

(2) The lithographic printing plate precursor according to (1), in which A in the structural unit expressed by General Formulae (1) and (2) is a hydrogen atom.

(3) The lithographic printing plate precursor according to (1) or (2), in which, in General Formula (Ia), X is —CO—.

(4) The lithographic printing plate precursor according to any one of (1) to (3), in which, in General Formula (Ia), Y is —OR^{11b}, and said R^{11b} is an aliphatic hydrocarbon group with an α position-branched chain shape.

(5) The lithographic printing plate precursor according to (4), in which said R^{11b} is a tertiary butyl group.

(6) The lithographic printing plate precursor according to any one of (1) to (5), further including: an interlayer containing a compound having a phosphoric acid group or a phosphonic acid group between the support and the image recording layer.

(7) The lithographic printing plate precursor according to (6), in which the compound having the phosphoric acid group or the phosphonic acid group is a polymer compound.

(8) The lithographic printing plate precursor according to (6) or (7), in which the compound having the phosphoric acid group or the phosphonic acid group is a compound further having a hydrophilic group.

(9) A method for producing a plate including: image-exposing the lithographic printing plate precursor according to any one of (1) to (8), with an infrared ray laser; and removing an unexposed portion of an image recording layer by using at least one of printing ink and dampening water on a printing machine.

According to the invention, it is possible to obtain a thermal fusion-type lithographic printing plate precursor having excellent visibility and excellent on-board developability even after the lithographic printing plate precursor is preserved for a long period of time. Also, it is possible to obtain a thermal fusion-type lithographic printing plate precursor having excellent preservation stability.

### DESCRIPTION OF THE PREFERRED EMBODIMENTS

Hereinafter, the invention is described in detail. In this specification, “(meth)acrylate” means at least one of acrylate and methacrylate. In the same manner, a “(meth)acryloyl group”, a “(meth)acrylic acid”, and a “(meth)acrylic resin” means “at least one of an acryloyl group and a methacryloyl group, at least one of an acrylic acid and a methacrylic acid, and at least one of an acrylic resin and a methacrylic resin”, respectively.

[Lithographic Printing Plate Precursor]

The lithographic printing plate precursor according to the invention is a lithographic printing plate precursor including: an image recording layer containing (A) a thermoplastic fine particle polymer, (B) an infrared ray absorbing dye, and (C) a polyglycerol compound, on a support, in which the infrared ray absorbing dye is an infrared ray absorbing dye expressed by General Formula (I) below, and the polyglycerol compound is a compound having three or more structural units selected from structural units expressed by General Formulae (1) and (2) below.

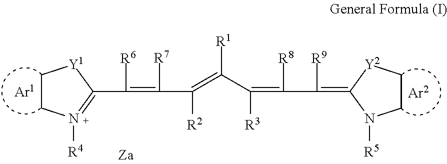

In General Formula (I), R¹ represents a group expressed by General Formula (Ia) below. Each of R² and R³ independently represents a hydrogen atom or an alkyl group, or R² and R³ represent atomic groups that are required for forming a cyclic structure by being linked to each other. Each of Ar¹ and Ar² independently represents an atomic group that is required for forming a benzene ring or a naphthalene ring. Each of Y¹ and Y² independently represents an sulfur atom or a dialkyl methylene group. Each of R⁴ and R⁵ independently represents an alkyl group. Each of R⁶, R⁷, R⁸, and R⁹ independently represents a hydrogen atom or an alkyl group. Za represents a counter ion that neutralizes electrical charges.

—NR¹⁰-L-X—Y General Formula (Ia)

In General Formula (Ia), R¹⁰ represents a hydrogen atom, an aliphatic hydrocarbon group, or a (hetero)aryl group, or an atomic group that is required for forming a cyclic structure by being linked to Y. L represents a single bond or a bivalent linking group. X represents —CO—, —SO₂—, or —SO—. Y represents —R^{11a}, —OR^{11b}, —NR¹²R¹³, or —CF₃. R^{11a} represents a hydrogen atom, an aliphatic hydrocarbon group, or a (hetero)aryl group. R^{11b} represents an aliphatic hydrocarbon group or a (hetero)aryl group. Each of R¹² and R¹³ independently represents a hydrogen atom, an aliphatic hydrocarbon group, or a (hetero)aryl group, or R¹² and R¹³ represent atomic groups that are required for forming a cyclic structure by being linked to each other.

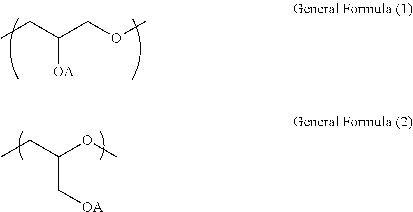

In General Formulae (1) and (2), A represents a hydrogen atom, an alkyl group having 1 to 4 carbon atoms, or an alkyl carbonyl group having 2 to 5 carbon atoms.

With the lithographic printing plate precursor of the invention, it is possible to manufacture a lithographic printing plate by on-board development on the printing machine after image exposure.

Hereinafter, the lithographic printing plate precursor according to the invention is described in detail.

[Image Recording Layer]

The image recording layer in the lithographic printing plate precursor according to the invention contains (A) a thermoplastic fine particle polymer, (B) an infrared ray absorption dye, and (C) a polyglycerol compound. Components contained in the image recording layer are described below.

[Thermoplastic Fine Particle Polymer]

With respect to the thermoplastic fine particle polymer contained in the image recording layer of the lithographic printing plate precursor according to the invention, a glass transition temperature (Tg) is preferably 60° C. to 250° C. Tg of the thermoplastic fine particle polymer is more preferably 70° C. to 140° C. and still more preferably 80° C. to 120° C.

Examples of the thermoplastic fine particle polymer having Tg of 60° C. or greater suitably include thermoplastic fine particle polymers disclosed in Reseach Disclosure No. 33303 of January 1992, JP1997-123387A (JP-H9-123387A), JP1997-131850A (JP-H9-131850A), JP1997-171249A (JP-H9-171249A), JP1997-171250A (JP-H9-171250A) and EP931647B.

Specific examples thereof include a homopolymer or a copolymer constituted with a monomer such as ethylene, styrene, vinyl chloride, methyl acrylate, ethyl acrylate, methyl methacrylate, ethyl methacrylate, vinylidene chloride, acrylonitrile, or vinyl carbazole, or a mixture thereof. Preferred examples thereof include polystyrene, and polymethacrylic acid methyl.

An average particle diameter of the thermoplastic fine particle polymer is preferably 0.005 μm to 2.0 μm. If the average particle diameter is too great, the resolution is deteriorated, and if the average particle diameter is too small, temporal stability is deteriorated. This value is applied, even in the case of the average particle diameter, in which two or more thermoplastic fine particle polymers are mixed. The average particle diameter is more preferably 0.01 μm to 1.5 μm and particularly preferably 0.05 μm to 1.0 μm. Polydispersity in a case where two or more types of thermoplastic fine particle polymers are mixed is preferably 0.2 or greater. The average particle diameter and the polydispersity are calculated by laser light scattering.

Two or more types of the thermoplastic fine particle polymers may be used in a mixed manner. Specifically, at least two or more types of the thermoplastic fine particle polymers having different particle sizes may be used or at least two or more types of the thermoplastic fine particle polymers having different Tg may be used. If the two or more types are used in mixture, coating film curing properties of the image portion are further enhanced, and printing durability is further enhanced when a lithographic printing plate is formed.

For example, if thermoplastic fine particle polymers having the same particle size are used, a certain degree of a gap exists between the thermoplastic fine particle polymers, and thus even if the thermoplastic fine particle polymers are melted and solidified by image exposure, curability of the coating film may not become a desired value. In contrast, if the thermoplastic fine particle polymers having different particle sizes are used, a void volume between the thermoplastic fine particle polymers can be reduced, and as a result, coating film curability of the image portion after image exposure can be enhanced.

In addition, if thermoplastic fine particle polymers having the same Tg are used, when the temperature increase of the image recording layer by the image exposure is not sufficient, the thermoplastic fine particle polymer is not sufficiently melted and solidified, and curability of the coating film may not become a desired value. In contrast, if thermoplastic fine particle polymers having different Tg are used in a mixed manner, even if temperature increase of the image recording layer due to the image exposure is not sufficient, the coating film curability of the image portion can be enhanced.

If two or more types of thermoplastic fine particle polymers having different Tg are used in a mixed manner, Tg of at least one type of thermoplastic fine particle polymers is preferably 60° C. or greater. At this point, the difference of Tg is preferably 10° C. or greater, and more preferably 20° C. or greater. In addition, a content of the thermoplastic fine particle polymer having Tg of 60° C. or greater is preferably 70% by mass or greater with respect to the total thermoplastic fine particle polymers, in view of on-board developability and printing durability.

The thermoplastic fine particle polymer may have a crosslinkable group. If the thermoplastic fine particle polymer having a crosslinkable group is used, a crosslinkable group is thermally reacted by heat generated in an image exposed portion and a cross link is formed between the polymers, the strength of the coating film in the image portion increases, and thus printing durability becomes more excellent. A functional group that performs a reaction in which a chemical bond is formed may be used as a crosslinkable group, and examples thereof include an ethylenically unsaturated group that performs a polymerization reaction (for example, an acryloyl group, a methacryloyl group, a vinyl group, and an allyl group), a group having an isocyanate group that performs an addition reaction or a block body thereof and an active hydrogen atom which is a reaction counterpart thereof (for example, an amino group, a hydroxy group, or a carboxyl group), an epoxy group that performs the addition reaction in the same manner, and an amino group, a carboxyl group or a hydroxy group, which is a reaction counterpart thereof, a carboxyl group that performs condensation reaction and a hydroxy group or an amino group, and an acid anhydride that performs a ring-opening addition reaction and an amino group or a hydroxy group.

Specific examples of the thermoplastic fine particle polymer that has a crosslinkable group include polymers that have a crosslinkable group such as an acryloyl group, a methacryloyl group, a vinyl group, an allyl group, an epoxy group, an amino group, a hydroxy group, a carboxyl group, an isocyanate group, acid anhydride, and a group in which these are protected. The introduction of these crosslinkable groups to a polymer may be performed at the time of polymerization of the fine particle polymer or may be performed by using a high molecular reaction after the polymerization of the fine particle polymer.

When a crosslinkable group is introduced at the time of the polymerization of a fine particle polymer, emulsion polymerization or suspension polymerization of a monomer having a crosslinkable group is preferable. Specific examples of the monomer having the crosslinkable group include allyl methacrylate, allyl acrylate, vinyl methacrylate, vinyl acrylate, glycidyl methacrylate, glycidyl acrylate, 2-isocyanate ethyl methacrylate, or block isocyanate with alcohols thereof, 2-isocyanate ethyl acrylate or block isocyanate with alcohols thereof, 2-aminoethyl methacrylate, 2-aminoethyl acrylate, 2-hydroxyethyl methacrylate, 2-hydroxyethyl acrylate, an acrylic acid, a methacrylic acid, maleic anhydride, bifunctional acrylate, and bifunctional methacrylate.

An example of the high molecular reaction used when the introduction of a crosslinkable group is performed after the polymerization of the fine particle polymer includes a high molecular reaction disclosed in WO96/34316A.

The thermoplastic fine particle polymer may react between fine particle polymers with a crosslinkable group interposed therebetween, and may react with a polymer compound or a low molecular compound which is added to an image recording layer.

The content of the thermoplastic fine particle polymer is preferably 40% by mass to 95% by mass, more preferably 50% by mass to 90% by mass, and particularly preferably 60% by mass to 85% by mass with respect to a solid content of the image recording layer.

[Infrared Ray Absorbing Dye]

The infrared ray absorbing dye included in the image recording layer of the lithographic printing plate precursor according to the invention is an infrared ray absorbing dye expressed by General Formula (I) below.

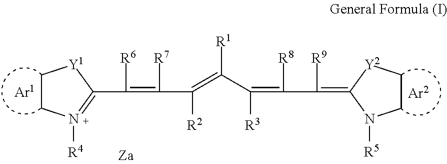

In General Formula (I), R¹ represents a group expressed by General Formula (Ia) below. Each of R² and R³ independently represents a hydrogen atom or an alkyl group, or R² and R³ represent atomic groups that are required for forming a cyclic structure by being linked to each other. Each of Ar¹ and Ar² independently represents an atomic group that is required for forming a benzene ring or a naphthalene ring. Each of Y¹ and Y² independently represents an sulfur atom or a dialkyl methylene group. Each of R⁴ and R⁵ independently represents an alkyl group. Each of R⁶, R⁷, R⁸, and R⁹ independently represents a hydrogen atom or an alkyl group. Za represents a counter ion that neutralizes electrical charges.

—NR¹⁰-L-X—Y General Formula (Ia)

In General Formula (Ia), R¹⁰ represents a hydrogen atom, an aliphatic hydrocarbon group, or a (hetero)aryl group, or an atomic group that is required for forming a cyclic structure by being linked to Y. L represents a single bond or a bivalent linking group. X represents —CO—, —SO₂—, or —SO—. Y represents —R^{11a}, —OR^{11b}, —NR¹²R¹³, or —CF₃. R^{11a} represents a hydrogen atom, an aliphatic hydrocarbon group, or a (hetero)aryl group. R^{11b} represents an aliphatic hydrocarbon group or a (hetero)aryl group. Each of R¹² and R¹³ independently represents a hydrogen atom, an aliphatic hydrocarbon group, or a (hetero)aryl group, or R¹² and R¹³ represent atomic groups that are required for forming a cyclic structure by being linked to each other.

Here, the expression “(hetero)aryl group” is used as a generic term of an aryl group or a heteroaryl group.

The infrared ray absorbing dye expressed by General Formula (I) is a group having structural characteristics in that R¹ is a group expressed by General Formula (Ia). According to these structural characteristics, the lithographic printing plate precursor containing the infrared ray absorbing dye expressed by General Formula (I) exhibits excellent visibility of an image by image exposure with an infrared ray. That is, if the lithographic printing plate precursor containing the infrared ray absorbing dye expressed by General Formula (I) is subjected to image exposure with an infrared ray, a group expressed by General Formula (Ia) is decomposed to generate an amino group, and an infrared ray absorbing dye is changed to a colored product. As a result, the exposed portion is colored and generates density difference with an unexposed portion, and thus visibility of an image portion is enhanced.

In General Formula (I), an alkyl group represented by R² or R³ is preferably an alkyl group having 12 or less carbon atoms. As a ring formed by linking R² and R³, a 5-membered ring or a 6-membered ring is preferable.

A benzene ring or a naphthalene ring represented by Ar¹ or Ar² may have a substituent, and examples thereof include an alkyl group having 12 or less carbon atoms, a halogen atom, or an alkoxy group having 12 or less carbon atoms.

The alkyl group represented by R⁴ or R⁵ is preferably an alkyl group having 20 or less carbon atoms. The alkyl group may have a substituent, and examples of the substituent include an alkoxy group having 12 or less carbon atoms, a carboxyl group, or a sulfo group.

The alkyl group represented by R⁶, R⁷, R⁸, or R⁹ is preferably an alkyl group having 12 or less carbon atoms.

The counter anion that neutralizes an electrical charge represented by Za is preferably a halide ion, a perchlorate ion, a tetrafluoroborate ion, a hexafluorophosphate ion, or a sulfonate ion, and more preferably a perchlorate ion, a hexafluorophosphate ion, or an arylsulfonate ion. In addition, if the infrared ray absorbing dye expressed by General Formula (I) has an anionic substituent in a structure thereof and thus neutralization of an electrical charge is not required, Za is not required.

In General Formula (Ia), the aliphatic hydrocarbon group represented by R¹⁰ includes an alkyl group, an alkenyl group, an alkynyl group, and the like. The number of the carbon atoms included in an aliphatic hydrocarbon group is preferably 40 or less and more preferably 20 or less. The aliphatic hydrocarbon group may have a substituent, and examples of the substituent include a halogen atom, an alkoxy group, and an aryl group.

The aryl group represented by R¹⁰ may include a monocyclic ring or a fused ring having two or more rings. Specifically, examples thereof include a phenyl group, an indenyl group, an α-naphthyl group, a β-naphthyl group, a fluorenyl group, a phenanthrenyl group, an anthracenyl group, and a pyrenyl group. As the aryl group, a phenyl group and a naphthyl group are preferable. The aryl group may have a substituent, and examples of the substituent include an alkyl group having 20 or less carbon atoms, a halogen atom, an alkoxy group, and an aryl group. The alkyl group may further have a substituent, and examples of the substituent include an alkoxy group, a carboxyl group, and a sulfo group.

The heteroaryl group represented by R¹⁰ preferably includes any one of an oxygen atom, a nitrogen atom, a sulfur atom, and a selenium atom, as a heteroatom. The heteroatom is more preferably an oxygen atom, a nitrogen atom, and a sulfur atom, and particularly preferably an oxygen atom and a nitrogen atom. The heteroaryl group may have a substituent, and examples of the substituent include groups or atoms exemplified as substituents that may be included in the aryl group.

In view of visibility enhancement, R¹⁰ is preferably an alkyl group having 40 or less carbon atoms which may be substituted or an aryl group which may be substituted, and is more preferably an alkyl group having 20 or less carbon atoms which may be substituted.

The aliphatic hydrocarbon group that is represented by R^{11a} or R^{11b} includes an alkyl group, an alkenyl group, an alkynyl group, and the like. The number of carbon atoms included in the aliphatic hydrocarbon group is preferably 40 or less and more preferably 20 or less. The aliphatic hydrocarbon group may have a substituent, and examples of the substituent include a halogen atom, an alkoxy group, and an aryl group.

The aryl group represented by R^{11a} or R^{11b} may have a monocyclic ring or a fused ring having two or more rings. Specifically, examples thereof include a phenyl group, an indenyl group, an α-naphthyl group, a β-naphthyl group, a fluorenyl group, a phenanthrenyl group, an anthracenyl group, and a pyrenyl group. As the aryl group, a phenyl group and a naphthyl group are preferable. The aryl group may have a substituent, and examples of the substituent include an alkyl group having 20 or less carbon atoms, a halogen atom, an alkoxy group, and an aryl group. The alkyl group may further have a substituent, and examples of the substituent include an alkoxy group, a carboxyl group, and a sulfo group.

The heteroaryl group represented by R^{11a} or R^{11b} preferably includes any one of an oxygen atom, a nitrogen atom, a sulfur atom, and a selenium atom, as a heteroatom. The heteroatom is more preferably an oxygen atom, a nitrogen atom, and a sulfur atom, and particularly preferably an oxygen atom and a nitrogen atom. The heteroaryl group may have a substituent, and examples of the substituent include groups or atoms exemplified as substituents that may be included in the aryl group.

In view of visibility enhancement, R^{11b} is preferably an aliphatic hydrocarbon group with an α position-branched chain shape, more preferably a secondary or tertiary aliphatic hydrocarbon group, and particularly preferably a tertiary butyl group.

The aliphatic hydrocarbon group represented by R¹² or R¹³ includes an alkyl group, an alkenyl group, and an alkynyl group. The number of carbon atoms included in the aliphatic hydrocarbon group is preferably 40 or less and more preferably 20 or less. The aliphatic hydrocarbon group may have a substituent, and examples of the substituent include a halogen atom, an alkoxy group, and an aryl group.

The aryl group represented by R¹² or R¹³ may include a monocyclic ring or a fused ring having two or more rings. Specifically, examples thereof include a phenyl group, an indenyl group, an α-naphthyl group, a β-naphthyl group, a fluorenyl group, a phenanthrenyl group, an anthracenyl group, and a pyrenyl group. As the aryl group, a phenyl group and a naphthyl group are preferable. The aryl group may have a substituent, and examples of the substituent include an alkyl group having 20 or less carbon atoms, a halogen atom, an alkoxy group, and an aryl group. The alkyl group may further have a substituent, and examples of the substituent include an alkoxy group, a carboxyl group, and a sulfo group.

The heteroaryl group represented by R¹² or R¹³ preferably includes any one of an oxygen atom, a nitrogen atom, a sulfur atom, and a selenium atom, as a heteroatom. The heteroatom is more preferably an oxygen atom, a nitrogen atom, and a sulfur atom, and particularly preferably an oxygen atom and a nitrogen atom. The heteroaryl group may have a substituent, and examples of the substituent include groups or atoms exemplified as the substituent that may be included in the aryl group.

A ring that is formed by linking R¹² and R¹³ is a nitrogen-containing heterocyclic ring. The nitrogen-containing heterocyclic ring may have a substituent, and examples thereof include groups or atoms exemplified as the substituent that may be included in the aryl group. The nitrogen-containing heterocyclic ring represents a single ring-type, double ring-type, or triple ring-type heterocyclic ring that may include 1 to 6 heteroatoms selected from a nitrogen atom, an oxygen atom, and a sulfur atom, in addition to the nitrogen atom to which R¹² and R¹³ are bonded. Examples of the nitrogen-containing heterocyclic ring include a 3 to 15-membered nitrogen-containing unsaturated single ring-type, double ring-type, or triple ring-type heterocyclic ring and a 3 to 15-membered nitrogen-containing saturated single ring-type, double ring-type, or triple ring-type heterocyclic ring. An example of the nitrogen-containing heterocyclic ring preferably includes a 5 to 10-membered nitrogen-containing heterocyclic ring. Specifically, examples of the 5 to 10-membered nitrogen-containing unsaturated heterocyclic ring include pyrrole, imidazole, triazole, tetrazole, pyrazole, azepine, diazepine, indole, isoindole, indazole, purine, benzoimidazole, benzotriazole, pyrroline, imidazoline, triazoline, tetrazoline, pyrazoline, dihydropyridine, tetrahydropyridine, dihydropyrazine, tetrahydropyrazine, dihydropyrimidine, tetrahydropyrimidine, dihydropyridazine, tetrahydropyridazine, dihydroazepine, tetrahydroazepine, dihydrodiazepine, tetrahydrodiazepine, dihydro-oxazole, dihydroisoxazole, dihydrothiazole, dihydroisothiazole, dihydrofurazan, dihydro-oxadiazole, dihydro-oxazine, dihydro-oxaziazine, dihydro-oxazepine, tetrahydro-oxazepine, dihydro-oxadiazepine, tetrahydro-oxadiazepine, dihydrothiadiazole, dihydrothiazine, dihydrothiadiazine, dihydrothiazepine, tetrahydrothiazepine, dihydrothiadiazepine, tetrahydrothiadiazepine, indoline, isoindoline, dihydroindazole, dihydroquinoline, tetrahydroquinoline, dihydroisoquinoline, tetrahydroisoquinoline, dihydrophthalazine, tetrahydrophthalazine, dihydronaphthyridine, tetrahydronaphthyridine, dihydroquinoxaline, tetrahydroquinoxaline, dihydroquinazoline, tetrahydroquinazoline, dihydrocinnoline, tetrahydrocinnoline, dihydrobenzoxazine, dihydrobenzothiazine, pyrazino morpholine, dihydrobenzoxazole, dihydrobenzothiazole, dihydrobenzoimidazole, hexahydroazocine, hexahydroazonine, hexahydrodiazocine, hexahydrodiazonine, octahydroazecine, and octahydrodiazecine.

In addition, examples of the 5 to 10-membered nitrogen-containing saturated heterocyclic ring include pyrrolidine, imidazolidine, triazolidine, tetrazolidine, pyrazolidine, piperidine, piperazine, perhydropyrimidine, perhydropyridazine, perhydroazepine, perhydrodiazepine, perhydroazocine, tetrahydro-oxazole (oxazolidine), tetrahydroisoxazole (isoxazolidine), tetrahydrothiazole (thiazolidine), tetrahydroisothiazole (isothiazolidine), tetrahydrofurazan, tetrahydro-oxadiazole (oxadiazolidine), tetrahydro-oxazine, tetrahydro-oxadiazine, perhydro-oxazepine, perhydro-oxadiazepine, tetrahydrothiadiazole (thiadiazolidine), tetrahydrothiazine, tetrahydrothiadiazine, perhydrothiazepine, perhydrothiadiazepine, morpholine, thiomorpholine, perhydroindazole, perhydroquinoline, perhydroisoquinoline, perhydrophthalazine, perhydronaphthyridine, perhydroquinoxaline, perhydroquinazoline, perhydrocinnoline, perhydrobenzoxazole, perhydrobenzothiazole, perhydrobenzoimidazole, perhydroazonine, perhydroazecine, perhydrodiazocine, perhydrodiazonine, perhydrodiazecine, perhydroindole, perhydroisoindole, azabicyclo[3.2.2]nonane, azabicyclo[3.3.2]decane, and azabicyclo[2.2.2]octane.

In view of visibility enhancement, R¹² and R¹³ is preferably an alkyl group having 40 or less carbon atoms that may be substituted and an aryl group that may be substituted, and more preferably an alkyl group having 20 or less carbon atoms that may be substituted.

The bivalent linking group represented by L is an alkylene group, an arylene group, —CO—, —O—, —NH—, and a bivalent linking group obtained by combining these groups. The carbon atoms included in the bivalent linking group is preferably 20 or less.

In view of visibility enhancement, L is preferably a single bond or a bivalent linking group obtained by combining two or more selected from an alkylene group, —CO—, —O—, and —NH— and more preferably a single bond or a bivalent linking group obtained by combining two or more selected from an alkylene group having 8 or less carbon atoms, —CO—, —O—, and —NH—.

In view of visibility enhancement, in the infrared ray absorbing dye expressed by General Formula (I), a group represented by R¹ is preferably a group that is decomposed by image exposure due to an infrared ray. As the group that is decomposed by image exposure due to an infrared ray, a group that is thermally decomposed at the time of image exposure is preferable, and, in this point of view, X in General Formula (Ia) is —CO—, —SO—, or —SO₂—. In view of visibility enhancement, X is preferably —CO— or —SO—. Further, in view of exhibiting an effect of exhibiting excellent visibility and maintaining excellent on-board developability after a lithographic printing plate precursor is preserved for a long period of time according to the invention, X is particularly preferably —CO—.

In addition, in view of visibility enhancement, Y is preferably —OR^{11b}. Here, R^{11b} is preferably an aliphatic hydrocarbon group with an α position-branched chain shape, more preferably a secondary or terthiary aliphatic hydrocarbon group, and particularly preferably a terthiarybutyl group.

The infrared ray absorbing dye expressed by General Formula (I) is synthesized by the well-known method. For example, the infrared ray absorbing dye can be synthesized with reference to disclosure in JP2008-544322A.

The content of the infrared ray absorbing dye expressed by General Formula (I) is preferably 0.25% by mass to 50% by mass, preferably 0.5% by mass to 30% by mass, and particularly preferably 0.7% by mass to 20% by mass with respect to a solid content of the image recording layer.

Hereinafter, specific examples of the infrared ray absorbing dye expressed by General Formula (I) used in the invention are provided, but the invention is not limited thereto.

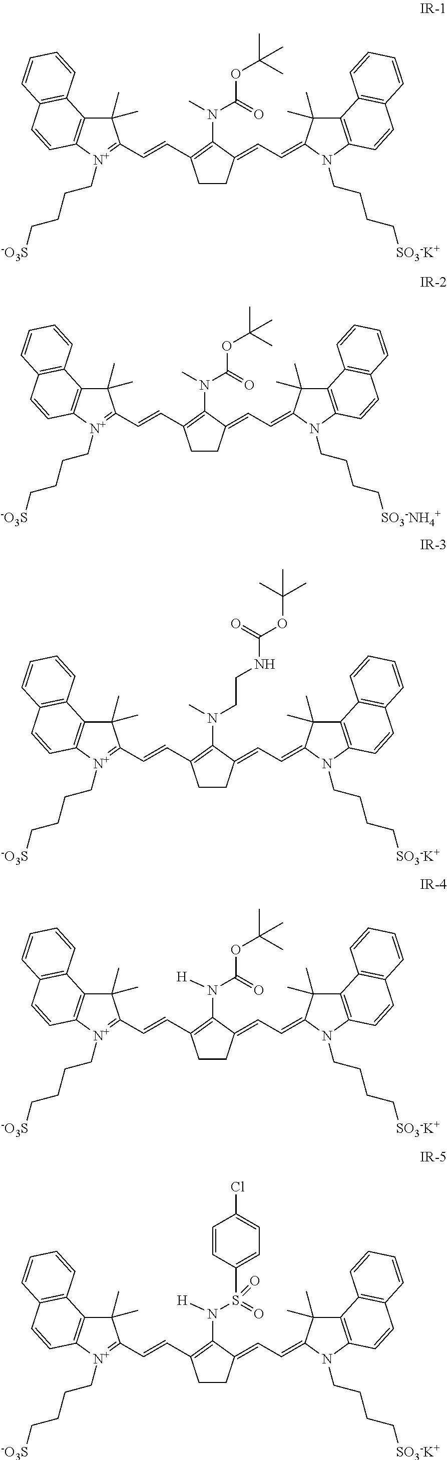

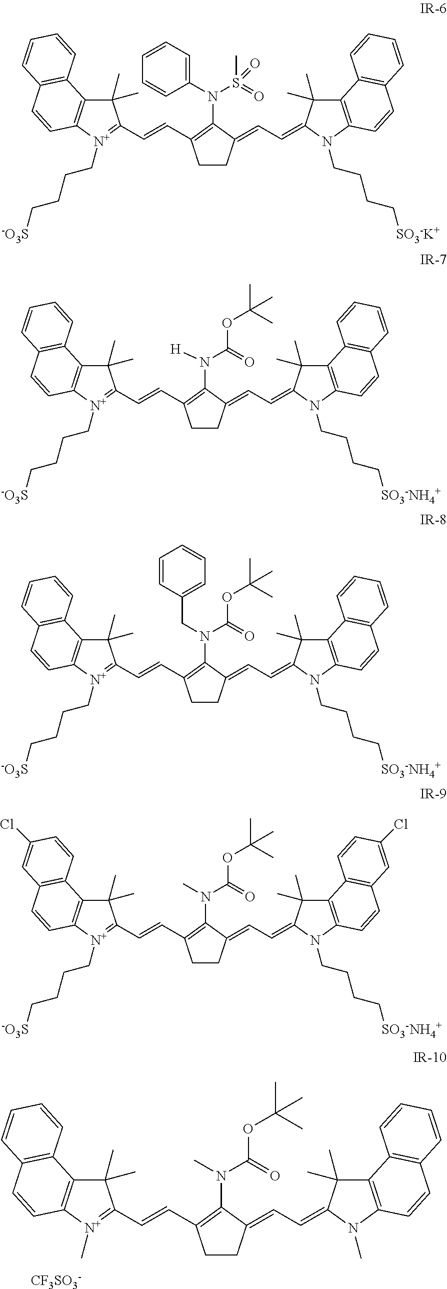

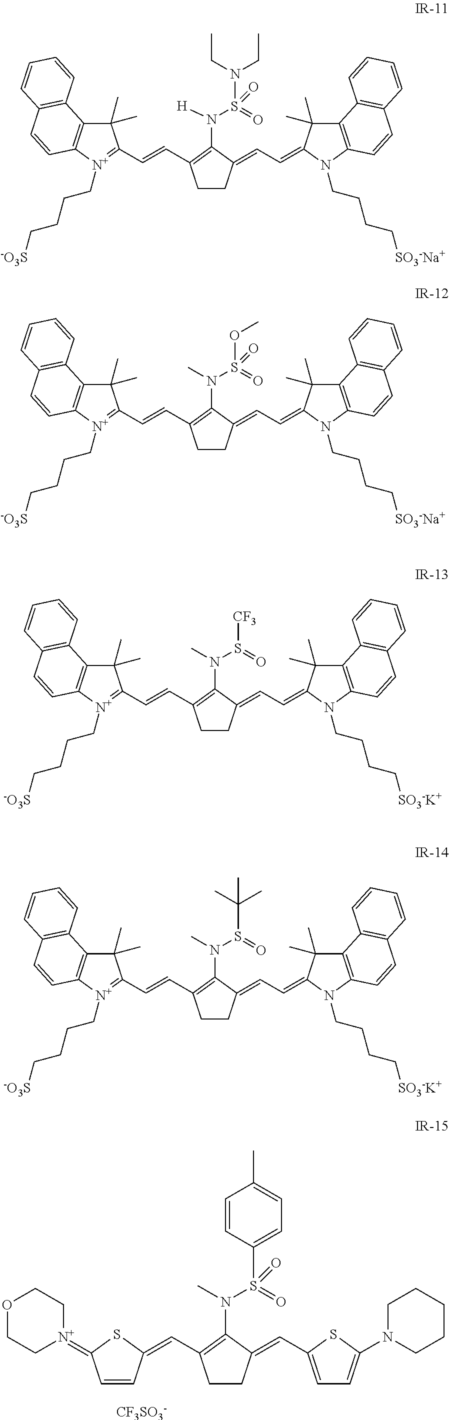

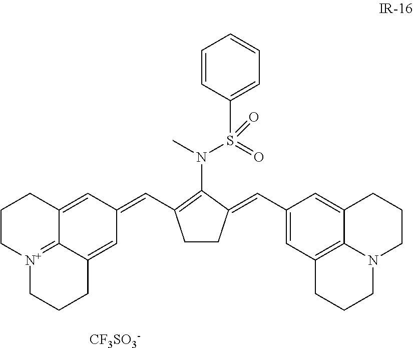

[Polyglycerol Compound]

The polyglycerol compound included in the image recording layer of the lithographic printing plate precursor according to the invention includes three or more structural units selected from structural units expressed by General Formulae (1) and (2) below.

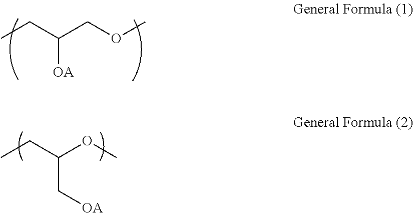

In General Formulae (1) and (2), A represents a hydrogen atom, an alkyl group having 1 to 4 carbon atoms, or an alkyl carbonyl group having 2 to 5 carbon atoms.

As A in General Formulae (1) and (2), a hydrogen atom, a methyl group, an ethyl group, a methyl carbonyl group, or an ethyl carbonyl group is preferable, and a hydrogen atom is particularly preferable.

The number of structural units expressed by General Formulae (1) and (2) in the polyglycerol compound is preferably 3 to 500, more preferably 3 to 200, still more preferably 3 to 100, and particularly preferably 6 to 60.

The hydroxyl value of the polyglycerol compound is preferably 670 to 1100 and more preferably 770 to 1100. The hydroxyl value is the mg number of potassium hydroxide required for neutralizing an acetic acid bonded to a hydroxy group when 1 g of the polyglycerol compound is acetylated.

The polyglycerol compound may be a straight chain compound or may be a branched compound. The branched compound has a structure, for example, in which A in General Formula (1) or (2) becomes a single bond, and in which a structural unit expressed by General Formula (1) or (2) is bonded to this, so as to form a branched chain. In this case, the polyglycerol compound includes a structural unit (here, O* represents a position at which a branched chain is bonded) expressed by (a) or (b) below. In addition, for the reason of synthesis, the polyglycerol compound may include a cyclic structural unit including a hydrogen atom, for example, a structural unit expressed by (c) below.

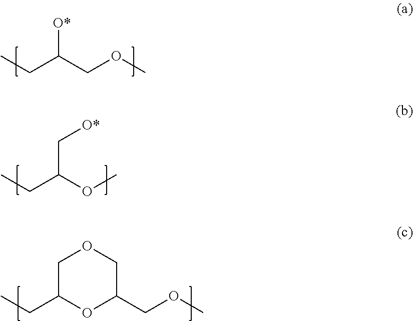

The terminal structure of the polyglycerol compound is any one of a hydroxy group, an alkoxy group having 1 to 4 carbon atoms, and an alkylcarbonyloxy group having 2 to 5 carbon atoms. It is preferable that all terminal structures are hydroxy groups.

The polyglycerol compound is substantially formed of only structural units expressed by General Formulae (1) and (2), even if the polyglycerol compound has plural hydroxy groups and a portion of the hydroxy group is substituted with an alkyl group having 4 or less carbon atoms or an alkyl carbonyl group having 5 or less carbon atoms, hydrophilicity of the polyglycerol compound is extremely high, and surfactant activity is not substantially exhibited. Therefore, at the time of on-board development, dampening water does not penetrate the exposed portion (image portion) of the image recording layer such that hydrophobicity of the image portion or strength of a coating film is not deteriorated, and thus ink storing properties of the image portion or printing durability can be satisfactorily maintained.

The polyglycerol compound is synthesized by a well-known method. For example, the polyglycerol compound is synthesized by referring to disclosures in polyglycerol ester (edited by Sakamoto Yakuhin kogyo Co., Ltd., 1994), Eur. J. Org. Chem., 2001, 875-896, and the like.

In addition, commercially available products can be used, and examples thereof include POLYGLYCERIN #310, POLYGLYCERIN #500, POLYGLYCERIN #750 (hereinafter, manufactured by Sakamoto Yakuhin kogyo Co., Ltd.), POLYGLYCERIN (manufactured by Yokkaichi Chemical Company Limited.), POLYGLYCERIN PGL 06, POLYGLYCERIN PGL 10, and POLYGLYCERIN PGL X (above manufactured by Daicel Corporation).

The content of the polyglycerol compound is preferably 0.1% by mass to 30% by mass and more preferably 0.5% by mass to 20% by mass with respect to the solid content of the image recording layer.

Hereinafter, specific examples of polyglycerol compounds used in the invention are provided, but the invention is not limited thereto.

Formula below (x+y=6) (1)

Formula below (x+y=10) (2)

Formula below (x+y=40) (3)

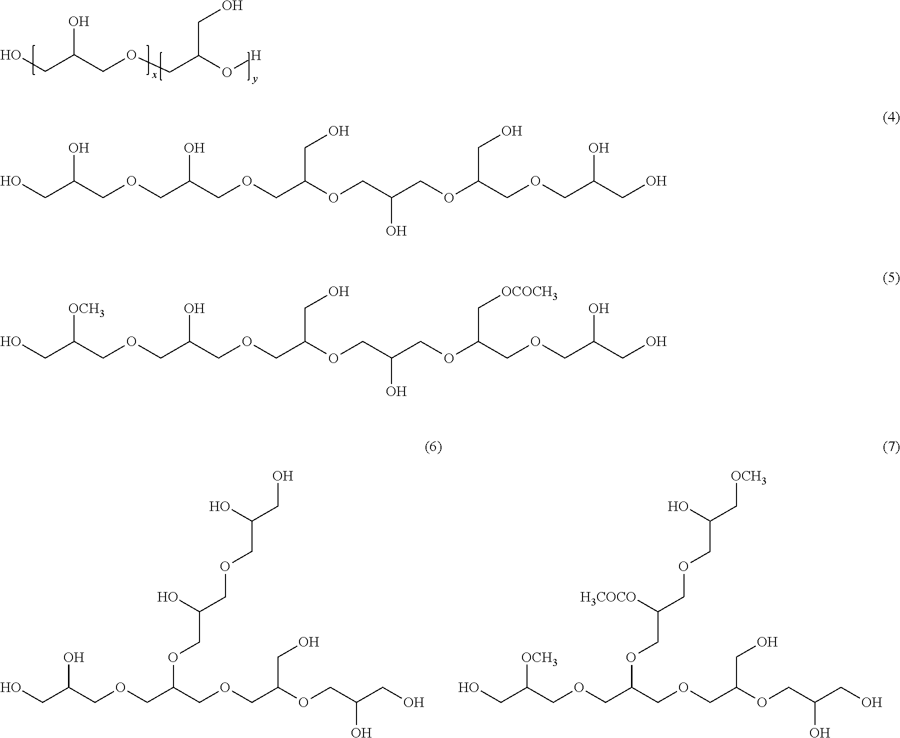

Together with the infrared ray absorbing dye expressed by General Formula (I), a polyglycerol compound is included in the image recording layer of the lithographic printing plate precursor according to the invention. As described above, visibility is enhanced by containing the infrared ray absorbing dye expressed by General Formula (I) in the image recording layer of the lithographic printing plate precursor. However, if this lithographic printing plate precursor is preserved, temporal on-board developability tends to be deteriorated. This tendency becomes remarkable as the infrared ray absorbing dye has excellent visibility. This phenomenon is considered to be caused by gradual decomposition of the infrared ray absorbing dye expressed by General Formula (I) during preservation of the lithographic printing plate precursor. That is, the infrared ray absorbing dye expressed by General Formula (I) is decomposed during the preservation of the lithographic printing plate precursor, a decomposition product such as gas is generated, and thus the decomposition product is accumulated in the image recording layer or between the image recording layer and the support, such that the penetration of the dampening water at the time of on-board development becomes slow.

In contrast, the deterioration of the temporal on-board developability can be suppressed by using a polyglycerol compound together. It is considered that this is because the polyglycerol compound has plural hydroxy groups, hydrophilicity of the polyglycerol compound is extremely high even if a portion of the hydroxy groups is substituted with an alkyl group having 4 or less carbon atoms or an alkyl carbonyl group having 5 or less carbon atoms, and thus the polyglycerol compound functions as a penetration path of dampening water at the time of on-board development.

In this manner, since it is possible to suppress the deterioration of the temporal on-board developability according to the invention, excellent visibility and excellent on-board developability can be compatible to each other even after the preservation of the lithographic printing plate precursor. In addition, staining of the non-image portion after preservation can be suppressed.

In addition, the polyglycerol compound has high hydrophilicity, and the surfactant activity is not substantially exhibited. Therefore, at the time of on-board development, the dampening water does not penetrate an exposed portion (image portion) of the image recording layer such that the hydrophobicity of the image portion or the coating film strength is not reduced, and thus ink storing properties or printing durability of the image portion can be satisfactorily maintained.

The image recording layer according to the invention may contain a hydrophilic resin. As the hydrophilic resin, for example, a hydroxy group, a hydroxyethyl group, a hydroxypropyl group, an amino group, an aminoethyl group, an aminopropyl group, a carboxyl group, a carboxylate group, a sulfo group, a sulfonato group, and a phosphate group are preferable.

Specific examples of the hydrophilic resin include gum arabic, casein, gelatin, starch derivatives, carboxymethyl cellulose and a sodium salt thereof, cellulose acetate, sodium alginate, vinyl acetate-maleic acid copolymers, styrene-maleic acid copolymers, polyacrylic acids and salts thereof, polymethacrylic acids and salts thereof, a homopolymer and a copolymer of hydroxyethyl methacrylate, a homopolymer and a copolymer of hydroxyethyl acrylate, a homopolymer and a copolymer of hydroxypropyl methacrylate, a homopolymer and a copolymer of hydroxypropyl acrylate, a homopolymer and a copolymer of hydroxybutyl methacrylate, a homopolymer and a copolymer of hydroxybutyl acrylate, polyethyleneglycols, hydroxypropylene polymers, polyvinyl alcohols, polyvinyl acetate having a degree of hydrolysis of at least 60% and preferably 80% of a degree of hydrolysis, polyvinyl formal, polyvinyl butyral, polyvinyl pyrrolidone, a homopolymer and a copolymer of acrylamide, a homopolymer and a copolymer of methacrylamide, and a homopolymer and a copolymer of N-methylolacrylamide.

The molecular weight of the hydrophilic resin is preferably 2,000 or greater. If the molecular weight is less than 2,000, sufficient coating film strength or printing durability is not obtained, and thus the molecular weight of less than 2,000 is not preferable.

The content of the hydrophilic resin is preferably 0.5% by mass to 30% by mass and more preferably 0.7% by mass to 20% by mass with respect to a solid content of the image recording layer.

Inorganic fine particles may be added to the image recording layer according to the invention. Suitable examples of the inorganic fine particle include silica, alumina, magnesium oxide, titanium oxide, magnesium carbonate, calcium alginate, or mixtures thereof. The inorganic fine particles are useful for prevention of a scratch at the time of conveyance, processing, and the like, for strengthening or surface roughening of a coating film or prevention of a load shift at the time of loading.

The average particle diameter of the inorganic fine particles is preferably 5 nm to 10 μm and more preferably 10 nm to 1 μm. In this scope, inorganic fine particles are stably dispersed with a thermoplastic fine particle polymer and the film strength of the image recording layer is sufficiently maintained, and thus the non-image portion in which a printing stain hardly occurs and hydrophilicity is excellent can be formed.

The inorganic fine particles can be easily obtained as commercially available products of colloidal silica dispersion and the like.

The content of the inorganic fine particles is preferably 1.0% by mass to 70% by mass and more preferably 5.0% by mass to 50% by mass with respect to a solid content of the image recording layer.

If necessary, a plasticizer can be added to the image recording layer according to the invention, in order to provide flexibility of the coating film. Examples of the plasticizer include polyethyleneglycol, tributyl citrate, diethyl phthalate, dibutyl phthalate, dihexyl phthalate, dioctyl phthalate, tricresyl phosphate, tributyl phosphate, trioctyl phosphate, and tetrahydrofurfuryl oleate.

With respect to the image recording layer according to the invention, if the fine particle polymer having a thermal reactive functional group (crosslinkable group) is used, a compound that initiates or promotes reaction of a thermal reactive functional group (crosslinkable group) can be added, if necessary. Examples of the compound that initiates or promotes reaction of a thermal reactive functional group include a compound that generates a radical or a cation due to heat, for example, lophine dimer, a trihalomethyl compound, peroxide, an azo compound, onium salts including diazonium salts and diphenyliodonium salts, acylphosphine, and imido sulfonate. The addition amount of these compounds is preferably 0.1% by mass to 50% by mass, more preferably 0.5% by mass to 30% by mass, and particularly preferably 0.8% by mass to 20% by mass with respect to a solid content of the image recording layer. In this scope, it is possible to obtain satisfactory reaction initiation or promotion effects without deteriorating on-board developability.

For the purpose of securing evenness of coating of the image recording layer, the image recording layer according to the invention may contain an anionic surfactant.

The corresponding anionic surfactant is not particularly limited, as long as the anionic surfactant achieves the purpose described above. Among them, an alkyl benzene sulfonic acid or a salt thereof, an alkyl naphthalene sulfonic acid or a salt thereof, a (di)alkyldiphenyl ether (di)sulfonic acid or a salt thereof, and an alkyl sulfuric acid ester salt are preferable.

The addition amount of the anionic surfactant is preferably 0.1% by mass to 30% by mass and more preferably 0.1% by mass to 20% by mass with respect to a solid content of the image recording layer, and in view of causing the strength of the image recording layer and the developability of the non-image portion to be compatible to each other, the addition amount is particularly preferably 0.1% by mass to 10% by mass.

[Forming of Image Recording Layer]

The image recording layer according to the invention is formed by dissolving or dispersing the respective components described above in a proper solvent, preparing a coating liquid, and coating a support. As the solvent, water or a mixed solvent of water and an organic solvent can be used, but the mixed use of water and an organic solvent is preferable in order to make a surface shape after coating satisfactory. The amount of the organic solvent is different according to the kind of the organic solvent, and thus may not be specified in an unconditional manner, but is preferably 5% by volume to 50% by volume with respect to the mixed solvent, generally. However, the organic solvent is required to be used in an amount in which a thermoplastic fine particle polymer does not aggregate. The solid content concentration of the coating liquid for the image recording layer is preferably 1% by mass to 50% by mass.

The organic solvent as the solvent of the coating liquid is preferably an organic solvent that is soluble to water. Specific examples thereof include an alcohol solvent such as methanol, ethanol, propanol, isopropanol, and 1-methoxy-2-propanol, a ketone solvent such as acetone and methyl ethyl ketone, and a glycol ether solvent such as ethylene glycol dimethyl ether, γ-butyrolactone, N,N-dimethylformamide, N,N-dimethylacet amide, tetrahydrofuran, and dimethylsulfoxide. Particularly, a boiling point is 120° C. or less, and an organic solvent having solubility to water (dissolved amount with respect to 100 g of water) of 10 g or more is preferable, and an organic solvent having solubility of 20 g or more is more preferable.

As the coating method of the coating liquid for the image recording layer, various kinds of methods can be used. Examples thereof include bar coater coating, rotary coating, spray coating, curtain coating, dip coating, air knife coating, blade coating, and roll coating. The coating amount (solid content) of the image recording layer on a support obtained after coating and drying varies depending on the use, but, is preferably 0.3 g/m² to 5.0 g/m² and more preferably 0.3 g/m² to 3.0 g/m², generally.

The lithographic printing plate precursor according to the invention preferably has an interlayer containing a compound having a phosphoric acid group or a phosphonic acid group between the support and the image recording layer. A stain (greasing) of a non-image portion after preservation is suppressed by providing this interlayer, and thus printing durability is enhanced.

The compound having a phosphoric acid group or a phosphonic acid group that is introduced to the interlayer may have a salt structure, and may be an inorganic salt or an organic salt. In the case of the inorganic salt, alkali metal salt is preferable, and sodium salt, lithium salt, or potassium salt is particularly preferable. In the case of the organic salt, an ammonium salt is preferable, and a quaternary ammonium salt is particularly preferable.

Examples of the compound having a phosphoric acid group or a phosphonic acid group include a phosphoric acid, a phosphonic acid, a phosphoric acid ester, an alkyl phosphonic acid, and salts thereof.

The phosphoric acid ester is preferably a compound expressed by General Formulae (P1) or (P2) below. These compounds may have a salt structure as described above.

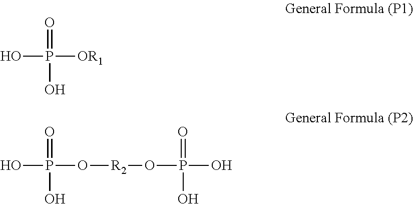

In General Formulae (P1) and (P2), R₁ represents an alkyl group, and an alkyl group having 1 to 6 carbon atoms is preferable. The alkyl group may have a substituent, and examples of the substituent include a carboxyl group and a hydroxy group. R₂ represents an alkylene group, and an alkylene group having 1 to 8 carbon atoms is preferable. The alkylene group may have a substituent, and examples of the substituent include a carboxyl group and a hydroxy group.

Hereinafter, specific examples of the compound expressed by General Formulae (P1) and (P2) are provided, but the invention is not limited thereto.

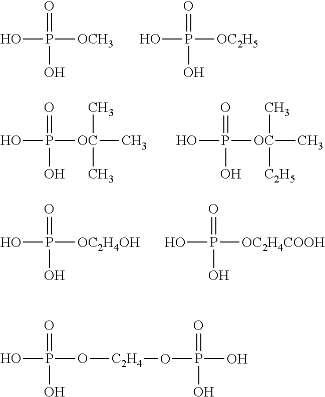

The alkyl phosphonic acid is preferably a compound expressed by General Formula (P3) or (P4) below. These compounds may have salt structures as above.

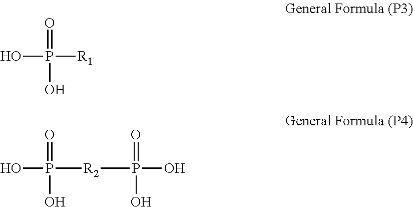

In General Formulae (P3) and (P4), R₁ represents an alkyl group or an alkenyl group, an alkyl group having 1 to 6 carbon atoms or an alkenyl group is preferable, and a methyl group or an ethyl group is particularly preferable. The alkyl group may have a substituent, and examples of the substituent include a carboxyl group and a hydroxy group. R₂ represents an alkyl group, an alkylene group having 1 to 8 carbon atoms is preferable, and a methylene group is particularly preferable. The alkylene may have a substituent, and examples of the substituent include a carboxyl group and a hydroxy group.

Hereinafter, specific examples of the compound expressed by General Formulae (P3) and (P4) are provided, but the invention is not limited thereto.

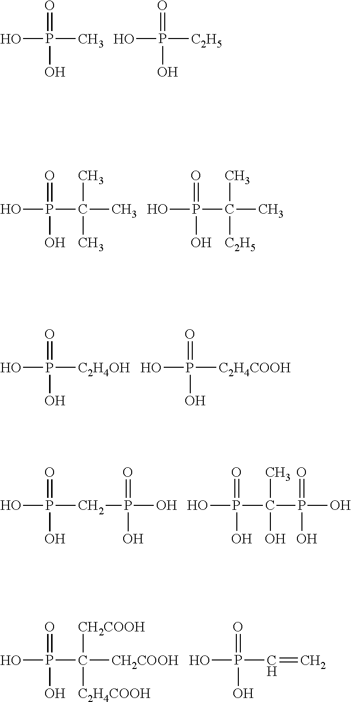

The compound having the phosphoric acid group or the phosphonic acid group is preferably a polymer compound. Examples thereof include a polymer compound having a repeating unit having a phosphoric acid group or a phosphonic acid group. If the polymer compound having the phosphoric acid group or the phosphonic acid group is caused to be contained in the interlayer, even after the lithographic printing plate precursor is preserved, a stain (greasing) of the non-image portion is suppressed, and thus an effect of enhancing printing durability can be obtained. In view of increasing this effect, the mass average molecular weight of the polymer compound is preferably 20,000 or greater.

As the repeating unit having the phosphoric acid group, a repeating unit expressed by General Formula (P5) below is preferable, and as the repeating unit having the phosphonic acid group, a repeating unit expressed by General Formula (P6) below is preferable.

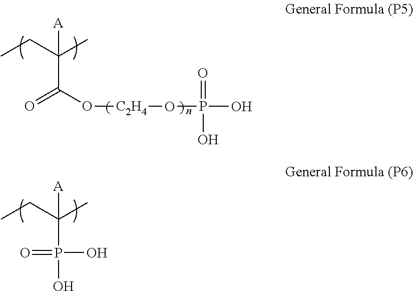

In General Formulae (P5) and (P6), A represents a hydrogen atom or a methyl group, and n represents an integer of 0 to 30.

The compound having a phosphoric acid group or a phosphonic acid group may have a hydrophilic group. For example, in addition to the repeating unit having the phosphoric acid group or the phosphonic acid group, a polymer compound having a repeating unit having a hydrophilic group expressed by General Formula (P7) below is preferable.

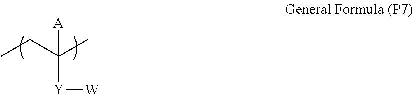

In General Formula (P7), W represents a hydrophilic group, and Y represents a bivalent linking group.

In General Formula (P7), examples of the hydrophilic group represented by W include a sulfonic acid group or a salt thereof, a hydroxy group, a polyoxyalkylene group, an amide group, and a carboxylic acid, or a salt thereof. Examples of the salt include an alkali metal salt (preferably, a sodium salt, a lithium salt, or a potassium salt) or an ammonium salt (preferably, a quaternary ammonium salt).

Examples of the bivalent linking group represented by Y include —CO—, —O—, —NH—, a bivalent aliphatic group, a bivalent aromatic group, and a bivalent linking group selected from the group obtained by combining these bivalent groups. Specific examples of the combined bivalent linking group are provided below. In the specific examples, left sides are bonded to main chains, and right sides are bonded to hydrophilic groups (W).

L1: —CO—NH-bivalent aliphatic group-O—CO—

L2: —CO-bivalent aliphatic group-O—CO—

L3: —CO—O-bivalent aliphatic group-O—CO—

L4: -bivalent aliphatic group-O—CO—

L5: —CO—NH-bivalent aromatic group-O—CO—

L6: —CO-bivalent aromatic group-O—CO—

L7: -bivalent aromatic group-O—CO—

L8: —CO-bivalent aliphatic group-CO—O-bivalent aliphatic group-O—CO—

L9: —CO-bivalent aliphatic group-O—CO-bivalent aliphatic group-O—CO—

L10: —CO-bivalent aromatic group-CO—O-bivalent aliphatic group-O—CO—

L11: —CO-bivalent aromatic group-O—CO-bivalent aliphatic group-O—CO—

L12: —CO-bivalent aliphatic group-CO—O-bivalent aromatic group-O—CO—

L13: —CO-bivalent aliphatic group-O—CO-bivalent aromatic group-O—CO—

L14: —CO-bivalent aromatic group-CO—O-bivalent aromatic group-O—CO—

L15: —CO-bivalent aromatic group-O—CO-bivalent aromatic group-O—CO—

L16: —CO—O-bivalent aromatic group-O—CO—NH-bivalent aliphatic group-O—CO—

L17: —CO—O-bivalent aliphatic group-O—CO—NH-bivalent aliphatic group-O—CO—

L18: —CO—NH—

L19: —CO—O—

Examples of the bivalent aliphatic group include an alkylene group, a substituted alkylene group, an alkenylene group, a substituted alkenylene group, an alkynylene group, a substituted alkynylene group, or a polyalkyleneoxy group. An alkylene group, a substituted alkylene group, an alkenylene group, or a substituted alkenylene group is preferable, and an alkylene group or a substituted alkylene group is more preferable.

With respect to the bivalent aliphatic group, a chain-shaped structure is preferable to a cyclic structure, and a straight chain-shaped structure is preferable to a chain-shaped structure having a branch. The number of carbon atoms included in the bivalent aliphatic group is preferably 1 to 20, more preferably 1 to 15, further preferably 1 to 12, still further preferably 1 to 10, and particularly preferably 1 to 8.

Examples of the substituent of the bivalent aliphatic group include a halogen atom (F, Cl, Br, I), a hydroxy group, a carboxyl group, an amino group, a cyano group, an aryl group, an alkoxy group, an aryloxy group, an acyl group, an alkoxycarbonyl group, an aryloxycarbonyl group, an acyloxy group, a monoalkylamino group, a dialkylamino group, an arylamino group, and a diarylamino group.

Examples of the bivalent aromatic group include an arylene group or a substituted arylene group. A phenylene, a substituted phenylene group, a naphthylene or a substituted naphthylene group is preferable.

Examples of the substituent of the bivalent aromatic group include an alkyl group, in addition to the example of the substituent of the bivalent aliphatic group.

Among L1 to L19 above, L1, L3, L5, L7, or L17 is preferable.

[Support]

The support used in the lithographic printing plate precursor according to the invention is a substrate having a hydrophilic surface or a substrate provided with a hydrophilic surface by applying a hydrophilic layer. Specifically, paper, paper on which plastic (for example, polyethylene, polypropylene, and polystyrene) is laminated, a metal plate (for example, aluminum, zinc, and copper), a plastic film (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinylacetal), paper, or a plastic film on which the metal described above is laminated or vapor deposited, or a substrate obtained by coating the substrate described above with a hydrophilic layer. Examples of a preferable support include an aluminum plate and a polyester film coated with a hydrophilic layer.

The aluminum plate includes a pure aluminum plate and an alloy plate including aluminum as a main component and a small amount of a foreign element, and further may be a plate on which plastic is laminated on an aluminum or aluminum alloy thin film. Examples of the foreign element included in the aluminum alloy include silicon, iron, manganese, copper, magnesium, chromium, zinc, bismuth, nickel, and titanium. The content of the foreign element in the alloy is 10% or less. In addition, the aluminum plate may be an aluminum plate made of an aluminum ingot used in a DC casting method or an aluminum plate made of an ingot by a continuous casting method. In the aluminum plate, materials which are well-known and frequently used in the related art, for example, JIS A 1050, JIS A 1100′, JIS A 3103, and JIS A 3005 can be appropriately used.

The thickness of the substrate is generally 0.05 mm to 0.6 mm, preferably 0.1 mm to 0.4 mm, and particularly preferably 0.15 mm to 0.3 mm.

In general, an aluminum plate for a lithographic printing plate precursor is produced by a degreasing step of removing rolling oil attached to an aluminum plate, a desmut process step of dissolving and removing a smut on a surface of the aluminum plate, and a roughening process step of roughening a surface of the aluminum plate.

Specifically, with respect to the aluminum plate, a dissolving process is performed by using an alkali aqueous solution such as caustic soda in order to remove a strong stain or a naturally oxidized coating film. In order to neutralize a remaining alkaline component after the process, a neutralizing treatment of immersing the aluminum plate in an acid such as a phosphoric acid, a nitric acid, a sulfuric acid, a hydrochloric acid, and a chromic acid, or a mixed acid thereof is performed. If necessary, in order to remove oils, fats, rust, and dust on the surface of the aluminum plate, a solvent degreasing process due to trichloroethylene and thinner, and an emulsion degreasing process using emulsion such as kerosene and triethanol may be performed.

When an electrochemical roughening process described below is performed after a dissolving process using an alkali aqueous solution or a neutralizing treatment due to acid, types and compositions of acid used in the neutralizing treatment is preferably matched with types and compositions of acid used in the electrochemical roughening process.

The roughening process of the surface of the aluminum plate is performed by various methods. Examples thereof include a method a mechanically roughening a surface, a method of electrochemically dissolving and roughening a surface, a method of selectively dissolving a surface in a chemical manner, and a combination of these methods.

As a mechanical roughening method, well-known methods such as ball graining, brush graining, blast graining, and buff graining method can be used. As a chemical roughening method, a method of immersing an aluminum plate in a saturated aqueous solution of an aluminum salt of a mineral acid as disclosed in JP1979-31187A (JP-S54-31187A) is preferable. There is an electrochemical roughening method that is performed by an alternating current or a direct current including acid such as a hydrochloric acid or a nitric acid. In addition, an electrolysis chemical roughening method using a mixed acid as disclosed in JP1979-63902A (JP-S54-63902A) can be used.

It is preferable that the roughening is performed in a range in which the central line average roughness (Ra) on the surface of the aluminum plate is 0.2 μm to 1.0 μm.

If necessary, with respect to the roughened aluminum plate, an alkali etching process is performed by using an aqueous solution of potassium hydroxide or sodium hydroxide, and further, a neutralizing treatment is performed.

According to the invention, it is preferable that a hydrophilic film is provided on an aluminum plate subjected to the roughening process as described above and another process, if necessary. Particularly, a support provided with a hydrophilic film having density of 1,000 kg/m³ to 3,200 kg/m³ has satisfactory coating film strength and stain resistance in printing, and also satisfactory heat insulating properties of preventing the diffusion of heat generated in the image recording layer to the support, and thus the support is suitable.

The measurement of the density can be calculated by the following equation, for example, from a mass of hydrophilic layer according to Mason method (obtaining a mass of a hydrophilic film by dissolving hydrophilic film by a mixed solution of chromic acid/phosphoric acid) and a thickness of a hydrophilic film obtained by observing a cross section by a scanning electron microscope (SEM).

Density (kg/m³)=(hydrophilic film mass per unit area)/film thickness

When hydrophilic film density is less than 1,000 kg/m³, a coating film strength decreases, it is likely that the decrease may adversely influence on image forming properties, printing durability, or the like, and it is likely that stain resistance in printing is deteriorated. If hydrophilic film density is greater than 3,200 kg/m³, sufficient heat insulation properties are not obtained, and thus it is likely that a sensitivity enhancing effect may decrease.

A method of providing a hydrophilic film is not particularly limited, and an anodic oxidation method, an vapor deposition method, a CVD method, a sol-gel method, a sputtering method, an ion plating method, a diffusion method, and the like can be appropriately used. In addition, a method of applying a solution obtained by mixing hollow particles with a hydrophilic resin or a sol-gel solution can be used.

Particularly, a process of manufacturing an oxide coating film by an anodic oxidation method, that is, an anodic oxidation process, is particularly suitably used. The anodic oxidation process can be performed by a method that is performed in the related art. Specifically, in an aqueous solution or a non-aqueous solution of a single substance or a combination of two or more types of a sulfuric acid, a phosphoric acid, a chromic acid, an oxalic acid, a sulfamic acid, and a benzenesulfonic acid, if a direct current or an alternating current is caused to flow to an aluminum plate, an anodic oxidation coating film which is a hydrophilic coating film can be formed on the surface of the aluminum plate.

The condition of the anodic oxidation process changes in various manners depending on used electrolytes, and thus it may not be specified in an unconditional manner, but generally, electrolyte concentration of 1% to 80%, a solution temperature of 5° C. to 70° C., electric current density of 0.5 A/dm² to 60 A/dm², an electric voltage of 1 V to 200 V, and electrolysis time of 1 second to 1,000 seconds are appropriate.

Among anodic oxidation processes, a method of performing an anodic oxidation process in a high electric current density in an electrolyte of an sulfuric acid disclosed in GB1412768B, a method of performing an anodic oxidation process with a phosphoric acid as an electrotylic bath disclosed in U.S. Pat. No. 3,511,661A, and the like are preferable. In addition, a multistage anodic oxidation process of performing an anodic oxidation process in a sulfuric acid and further performing an anodic oxidation process in a phosphoric acid may be performed.

In the invention, in view of effectively preventing a damage of a non-image portion to cause a stain, the amount of the anodic oxidation coating film is preferably 1.5 g/m² or greater.

As the support, a substrate that is roughening-processed as above and that has an anodic oxidation coating film may be used without change, but in order to further improve adhesiveness with an upper layer, hydrophilicity, stain resistance, heat insulation properties, and the like, if necessary, an enlarging process of micropores and a sealing process of micropores on an anodic oxidation coating film disclosed in JP2001-253181A and JP2001-322365A, a surface hydrophilization process of immersing a film in an aqueous solution containing a hydrophilic compound, and the like can be appropriately selected to be performed.

Examples of the hydrophilic compound which is suitable for a surface hydrophilization process include a compound having a polyvinylphosphonic acid and a sulfonic acid group, a saccharide compound, a citric acid, alkali metal silicate, zirconium potassium fluoride, and a phosphoric acid salt/inorganic fluorine compound.

[Overcoat Layer]

In order to protect a surface of a hydrophilic image recording layer from contamination due to lipophilic materials at the time of preservation and contamination due to fingerprints by the contact with a finger at the time of handling, the lithographic printing plate precursor according to the invention can include a hydrophilic overcoat layer on an image recording layer.

The overcoat layer can be easily removed from the printing machine, and contains a water-soluble resin or a water-swelling resin obtained by partially crosslinking a water-soluble resin.

The water-soluble resin is selected from a water-soluble natural polymer and a water-soluble synthetic polymer, and the water-soluble resin may be used singly or together with a crosslinking agent such that a coating film after coating and drying has film forming properties.

As specific examples of the preferably used water-soluble resin, examples of the natural polymer include gum arabic, water-soluble soybean polysaccharide, cellulose derivative (for example, carboxymethyl cellulose, carboxyethyl cellulose, methyl cellulose), a modified product thereof, white dextrin, pullulan, and enzyme degradation etherified dextrin, and examples of the synthetic polymer include polyvinyl alcohol (having a hydrolysis degree of polyvinyl acetate of 65% or higher), polyacrylic acid, an alkali metal salt or an amine salt thereof, a polyacrylic acid copolymer, an alkali metal salt or an amine salt thereof, an polymethacrylic acid, an alkali metal salt or an amine salt thereof, a vinyl alcohol/acrylic acid copolymer, an alkali metal salt or an amine salt thereof, polyacrylamide, a copolymer thereof, polyhydroxyethyl acrylate, polyvinyl pyrrolidone or a copolymer thereof, polyvinylmethyl ether, a vinylmethyl ether/maleic anhydride copolymer, poly-2-acrylamide-2-methyl-1-propane sulfonic acid, an alkali metal salt or an amine salt thereof, a poly-2-acrylamide-2-methyl-1-propanesulfonic acid copolymer, and an alkali metal salt or an amine salt thereof. According to a purpose, two or more types of water-soluble resins may be used in combination.

If an overcoat layer is formed on the image recording layer by partially crosslinking at least one type of the water-soluble resin, the crosslinking is performed by performing crosslinking reaction by using a reactive functional group having a water-soluble resin. The crosslinking reaction may be covalent bond crosslinking or may be ion bond crosslinking.

Adhesiveness of the surface of the overcoat layer decreases by crosslinking and thus handling properties of the lithographic printing plate precursor are enhanced, but, if crosslinking is performed too intensively, the overcoat layer becomes lipophilic, and thus the removing of the overcoat layer on the printing machine becomes difficult, and thus moderate partial crosslinking is preferable. The degree of preferable partial crosslinking is a degree in which, when a lithographic printing plate precursor is immersed in water at 25° C., the overcoat layer is not eluted for a period of time of 30 seconds to 10 minutes and remains, but the elution of the overcoat layer is acknowledged for a period of time of 10 minutes or longer.

Examples of the compound (crosslinking agent) used in the crosslinking reaction include a well-known multifunctional compound having crosslinking properties, and specific examples thereof include a polyepoxy compound, a polyamine compound, a polyisocyante compound, a polyalkoxysilyl compound, a titanate compound, an aldehyde compound, a polyvalent metal salt compound, and hydrazine.

The crosslinking agent may be used singly or two or more types thereof may be used in combination. A particularly preferable crosslinking agent is a water-soluble crosslinking agent, but the water-insoluble crosslinking agent may be dispersed in water depending on the dispersing agent to be used.

Examples of the preferable combination of a water-soluble resin and a crosslinking agent include a carboxylic acid-containing water-soluble resin/a polyvalent metallic compound, a carboxylic acid-containing water-soluble resin/a water-soluble epoxy resin, and a hydroxy group-containing resin/dialdehydes.

The suitable addition amount of the crosslinking agent is 2% by weight to 10% by weight of a water-soluble resin. In this range, contamination of the image recording layer by a lipophilic material can be prevented without deteriorating removability of the overcoat layer on the printing machine.

In order to enhance sensitivity, the overcoat layer may contain a water-soluble infrared ray absorption agent. The infrared ray absorbing dye which is used in the image recording layer is suitably used.

For the purpose of securing evenness of coating, in the case of performing coating with an aqueous solution, a nonionic surfactant can be mainly added to the overcoat layer. Specific examples of the nonionic surfactant include sorbitan tristearate, sorbitan monopalmitate, sorbitan trioleate, stearic acid monoglyceride, polyoxyethylene nonylphenyl ether, and polyoxyethylene dodecyl ether. The addition amount of the nonionic surfactant is preferably 0.05% to 5% and more preferably 1% to 3% with respect to a solid content of the overcoat layer.

When the water-soluble resin is not crosslinked, the thickness of the overcoat layer is preferably 0.1 μm to 4.0 μm and more preferably 0.1 μm to 1.0 μm. When the water-soluble resin is partially crosslinked, the thickness is preferably 0.1 μm to 0.5 μm and more preferably 0.1 μm to 0.3 μm. In this range, contamination of the image recording layer by the lipophilic material can be prevented without deteriorating the removability of the overcoat layer on the printing machine.

[Method for Producing Plate]

The method for producing the lithographic printing plate precursor according to the invention is described below. The production of the lithographic printing plate precursor according to the invention includes a step of image-exposing a lithographic printing plate precursor and a step of performing on-board development on a plate precursor for lithographic printing after exposure.

Image exposure is performed, for example, by scanning exposure with an infrared ray laser or infrared ray lamp exposure, but a semiconductor laser that radiates an infrared ray in a wavelength of 700 nm to 1200 nm and exposure with a solid high power infrared ray laser such as a YAG laser is suitable.

The lithographic printing plate precursor according to the invention is preferably exposed with a laser, a pulse laser, a solid laser, or a semiconductor laser. With respect to exposure amount in this case, the surface exposure strength before modulation to a printing image is preferably 0.1 J/cm² to 10 J/cm² and more preferably 0.1 J/cm² to 1 J/cm².

Without further processing, the image-exposed lithographic printing plate precursor is subjected to on-board development by a normal printing starting operation of supplying dampening water and ink after being attached to an impression cylinder of a printing machine, and can continuously perform printing.

When an exposure device is mounted on a printing machine, after the lithographic printing plate precursor is installed on a plate cylinder of the printing machine, exposure is performed by the exposure device of the printing machine, on-board development is continuously performed, and printing can be performed.

According to the invention, a plate producing method of removing an unexposed portion of the image recording layer by using at least one of printing ink and dampening water on the printing machine, after the lithographic printing plate precursor described above is image-exposed with infrared ray laser, is preferable.

### EXAMPLES

Hereinafter, the invention is described in detail with reference to examples, but the invention is not limited thereto. In addition, unless being specified otherwise for the polymer compound, a molecular weight is a mass average molar mass (Mw), and a ratio of a repeating unit is a mole percentage.

Synthesization examples of the infrared ray absorbing dye expressed by General Formula (I) are provided below.

### Synthesization Example 1

### Synthesization of Infrared Ray Absorbing Dye IR-1

According to schemes below, an infrared ray absorbing dye IR-1 was synthesized.

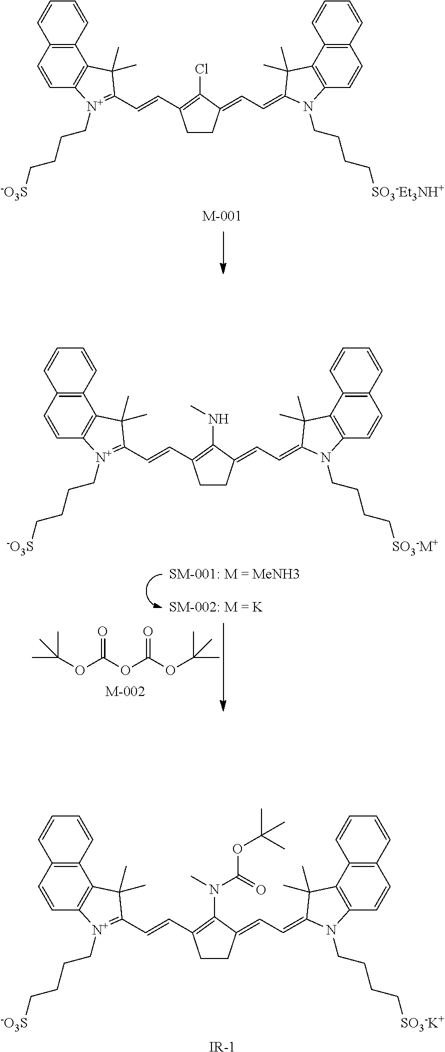

M-001 (230.0 g) synthesized as disclosed in U.S. Pat. No. 5,576,443A was added and dissolved in methanol (600 ml), and an aqueous 40% w/w solution (200 ml) of methylamine was added to this solution at room temperature. After stirring was performed for 1 hour at 40° C., isopropanol (250 ml) was added and a reaction mixture was cooled to 5° C. After a generated deposit was taken by filtering, washing was performed with an ice-cooling mixture (100 ml) of isopropanol/water (9/1) twice, and air drying was performed, so as to obtain SM-001 (199.5 g).

SM-001 (199.5 g) was dissolved in methanol (1.8 l), a solution of KOH (41.6 g) in water (120 ml) was added over 30 minutes, while being violently stirred. After being stirred for 1 hour at room temperature, a reaction mixture was cooled to 15° C. After a generated deposit was taken by filtering, washing was performed on a filter with cold ethanol (100 ml) twice, and air drying was performed, so as to obtain SM-002 (177.2 g).

M-002 (8.7 g) and KOt-Bu (1.3 g) were added to a suspension liquid in dimethylsulfoxide (30 ml) of SM-002 (8.2 g). After this mixture was stirred for 3 days at room temperature and cooled to 5° C., methanesulfonic acid (0.78 ml) was added, and a deposit was generated by using a mixture (200 ml) of ethyl acetate/water (100/1). The deposit was suspended in acetone, filtered, and dried, so as to obtain an infrared ray absorbing dye IR-1 (9.4 g).

### Synthesization Example 2

### Synthesization of Infrared Ray Absorbing Dye IR-5

According to schemes below, an infrared ray absorbing dye IR-5 was synthesized.

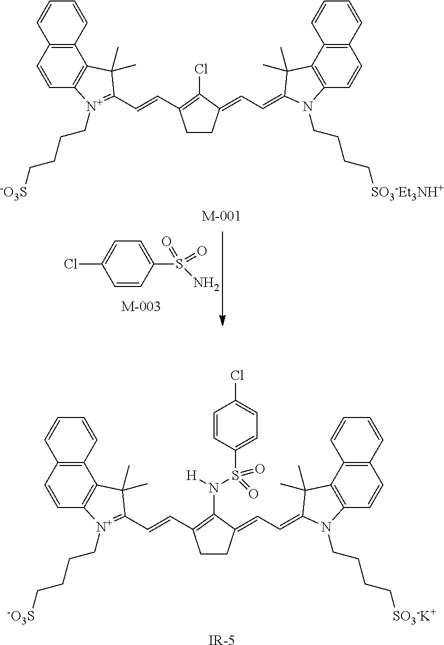

KOt-Bu (3.36 g) was added to a suspension liquid in sulfolane (60 ml) of M-001 (8.95 g) and M-003 (3.03 g) synthesized according to U.S. Pat. No. 5,576,443A at room temperature. After being stirred for 30 minutes at 90° C., a reaction mixture was cooled to room temperature, and a methanesulfonic acid (1.3 ml), water (3 ml), and acetone (120 ml) were added, and thus a deposit was generated. The deposit was taken by filtering, dissolved in water (20 ml), and added to acetone (500 ml), and the generated deposit was taken by filtering and dried, so as to obtain an infrared ray absorbing dye IR-5 (10.2 g).

In addition, an infrared ray absorbing dye for comparison IR-C was synthesized according to schemes below.

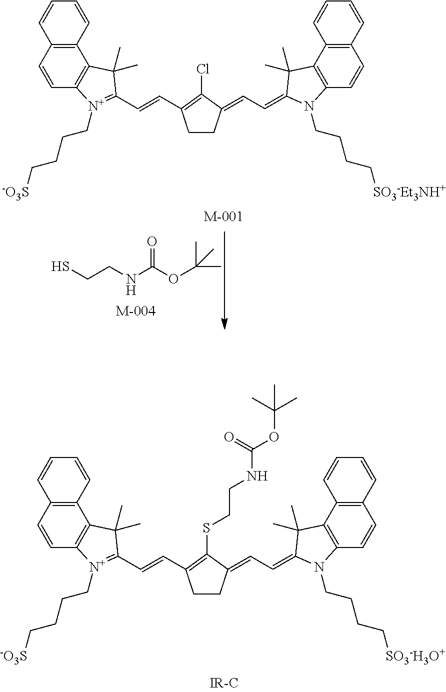

M-001 (8.95 g) synthesized as disclosed in U.S. Pat. No. 5,576,443A was dissolved in methanol (30 ml), and M-004 (2.12 g) and triethylamine (1.66 ml) were added to this solution. After being stirred for one hour at room temperature, a reaction mixture was diluted with ethyl acetate (150 ml), and methanesulfonic acid (0.77 ml) was added, so as to precipitate crystals. The precipitated crystals were filtered, washed with ethyl acetate, and dried in vacuum, so as to obtain an infrared ray absorbing dye for comparison IR-C (5.6 g) as reddish brown crystalline powder.

Hereinafter, synthesization examples of the polymer used in the interlayer are described.

(Synthesization of Interlayer Polymer A)

A solvent obtained by mixing n-propanol and water in a volume ratio of 4:1 was put into a reaction flask and heated to 70° C. while being purged with nitrogen. The purging with nitrogen was continuously performed during synthesization. Separately, 35 g of methacryloyl ethyl dimethyl sulfopropyl ammonium hydroxide, 15 g of poly(ethyleneglycol)methacrylate, and about 0.6 mols of azobisisobutyronitrile with respect to a monomer were dissolved in a solvent obtained by mixing n-propanol and water in a volume ratio of 4:1, so as to be a solution of 50% by weight. This solution was moved to a dropping funnel and slowly dripped to a solvent in a reaction flask. After dripping, stirring was performed for 10 hours. An excessive solvent was removed in vacuum, and an obtained product was refined so as to obtain a polymer A.

(Synthesization of Interlayer Polymer B)

According to a method disclosed in JP2007-118579A, an interlayer polymer B below was synthesized.

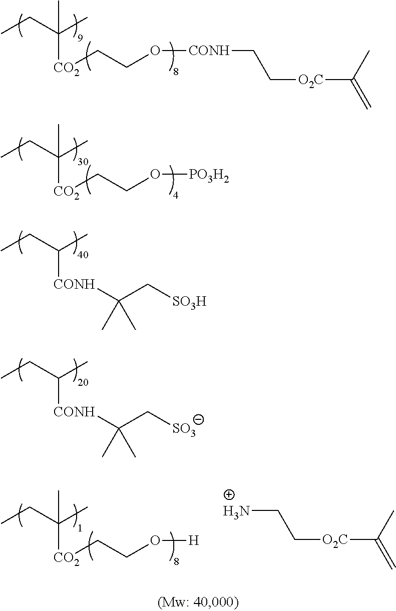

(Synthesization of Interlayer Polymer C)

According to the method disclosed in JP2007-118579A, an interlayer polymer C was synthesized.

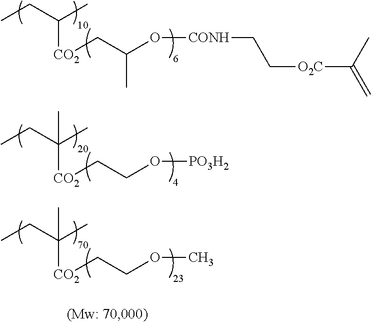

### Examples 1 to 10 and Comparative Examples 1 to 6

### [Production of Lithographic Printing Plate Precursor]

Production of Support

(Production of Support)

Degreasing was performed by immersing an aluminum plate having a thickness of 0.19 mm at 60° C. for 8 seconds, in a sodium hydroxide aqueous solution of 40 g/l, and washing was performed for 2 seconds with demineralized water. Subsequently, an electrochemical roughening process was performed on an aluminum plate for 15 seconds by using an alternating current, at a temperature of 33° C. and an electric current density of 130 A/dm², in an aqueous solution of containing a hydrochloric acid of 12 g/l and aluminum sulfate of 38 g/l (18 hydrate). After washing was performed for 2 seconds with demineralized water, an aluminum plate was subjected to a desmut process by etching the aluminum plate for 4 seconds at 70° C. in a sulfuric acid aqueous solution of 155 g/l, and washing was performed for 2 seconds at 25° C. with demineralized water. The aluminum plate was subjected to an anodic oxidation process at a temperature of 45° C. and electric current density of 22 A/dm² for 13 seconds in the sulfuric acid aqueous solution of 155 g/l, and the aluminum plate was washed for 2 seconds with demineralized water. Further, a post process was performed for 10 seconds at 40° C. by using a polyvinylphosphonic acid aqueous solution of 4 g/l, washing was performed for 2 seconds at 20° C. with demineralized water, and drying was performed. The support that was obtained in this manner had a surface roughness Ra of 0.21 μm and an anodic oxidation coating film amount of 4 g/m².

(Forming of Interlayer)

Interlayer coating liquids A to C having compositions below were produced by using the interlayer polymers A to C above. The support was coated with the interlayer coating liquids, and the interlayer coating liquids was dried at 100° C. for 60 seconds, so as to form an interlayer. Application amounts of the interlayer polymer after drying are presented in Table 1.

(Interlayer coating liquid A)

| | | |
|---|---|---|
| Interlayer polymer A | 0.017 | g |
| n-propanol | 8 | g |
| Water | 2 | g |

(Interlayer coating liquid B)

| | | |
|---|---|---|
| Interlayer polymer B | 0.017 | g |
| Methanol | 9 | g |
| Water | 1 | g |

(Interlayer coating liquid C)

| | | |
|---|---|---|
| Interlayer polymer C | 0.017 | g |
| Methanol | 9 | g |
| Water | 1 | g |

(Production of Lithographic Printing Plate Precursor)

An image recording layer coating liquid containing components such as a thermoplastic fine particle polymer, an infrared ray absorbing dye, and a polyglycerol compound as described in Table 1 below was prepared, pH thereof was adjusted to 3.6, the aqueous coating liquid was applied to the support or on an interlayer, drying was performed for 1 minute at 50° C., and an image recording layer was formed, such that a lithographic printing plate precursor was produced. The application amounts of components of the image recording layer after drying are presented in Table 1.

TABLE 1

| | | | Image recording layer | | | | | | | |
|---|---|---|---|---|---|---|---|---|---|---|
| | Interlayer | | Coating amount of | Infrared ray | | Polyglycerol compound or | | Other components | | Coating |
| | | Coating | thermoplastic fine | absorbing dye | | Comparative compound | | | Coating | amount of |
| | Interlayer | amount | particle polymer | | Coating amount | | Coating amount | | amount | surfactant |
| | polymer | (g/cm²) | (g/cm²) | Type | (g/cm²) | Type | (g/cm²) | Type | (g/cm²) | (g/cm²) |
| Example 1 | None | — | 0.693 | IR-1 | 1.10 × 10⁻⁴ | PG-1 | 0.07 | — | — | 0.007 |
| Example 2 | None | — | 0.693 | IR-1 | 1.10 × 10⁻⁴ | PG-2 | 0.07 | — | — | 0.007 |
| Example 3 | None | — | 0.693 | IR-5 | 0.99 × 10⁻⁴ | PG-3 | 0.07 | — | — | 0.007 |
| Example 4 | A | 0.01 | 0.693 | IR-1 | 1.10 × 10⁻⁴ | PG-1 | 0.07 | PVA | 0.09 | 0.007 |
| Example 5 | B | 0.01 | 0.693 | IR-1 | 1.10 × 10⁻⁴ | PG-1 | 0.07 | PVA | 0.09 | 0.007 |
| Example 6 | B | 0.01 | 0.693 | IR-1 | 1.10 × 10⁻⁴ | PG-2 | 0.07 | PAA | 0.09 | 0.007 |
| Example 7 | B | 0.01 | 0.693 | IR-1 | 1.10 × 10⁻⁴ | PG-3 | 0.07 | PAA | 0.09 | 0.007 |
| Example 8 | C | 0.01 | 0.693 | IR-1 | 1.10 × 10⁻⁴ | PG-3 | 0.07 | PVA | 0.09 | 0.007 |
| Example 9 | C | 0.01 | 0.693 | IR-5 | 1.10 × 10⁻⁴ | PG-1 | 0.07 | PVA | 0.09 | 0.007 |
| Example 10 | C | 0.01 | 0.693 | IR-5 | 1.10 × 10⁻⁴ | PG-2 | 0.07 | PAA | 0.09 | 0.007 |
| Comparative | None | — | 0.693 | IR-1 | 1.10 × 10⁻⁴ | — | — | — | — | 0.007 |
| Example 1 | | | | | | | | | | |
| Comparative | B | 0.01 | 0.693 | IR-1 | 1.10 × 10⁻⁴ | — | — | PVA | 0.09 | 0.007 |
| Example 2 | | | | | | | | | | |
| Comparative | None | — | 0.693 | IR-1 | 1.10 × 10⁻⁴ | Compound X | 0.07 | PVA | 0.09 | 0.007 |
| Example 3 | | | | | | | | | | |
| Comparative | None | — | 0.693 | IR-1 | 1.10 × 10⁻⁴ | Compound Y | 0.07 | PVA | 0.09 | 0.007 |
| Example 4 | | | | | | | | | | |
| Comparative | None | — | 0.693 | IR-1 | 1.10 × 10⁻⁴ | Compound Z | 0.07 | PVA | 0.09 | 0.007 |
| Example 5 | | | | | | | | | | |
| Comparative | None | — | 0.693 | IR-C | 1.10 × 10⁻⁴ | PG-1 | 0.07 | PVA | 0.09 | 0.007 |
| Example 6 | | | | | | | | | | |

Thermoplastic fine particle polymers, polyglycerol compounds PG-1 to PG-3, comparative compounds X to Z, other components PAA and PVA, surfactants, and an infrared ray absorbing dye IR-C used in the image recording layer coating liquid were as presented below. The infrared ray absorbing dyes IR-1 and IR-5, and an infrared ray absorbing dye for comparison IR-C were infrared ray absorbing dyes as described above.

Thermoplastic fine particle polymer: styrene/acrylonitrile copolymer (molar ratio: 50/50), Tg: 99° C., Average particle diameter: 61 nm

Polyglycerol compound PG-1: Polyglycerin PGL 10 (the number of repeating units: 10) (manufactured by DAICEL Corporation)

Polyglycerol compound PG-2: Polyglycerin PGL 6 (the number of repeating units: 6) (manufactured by DAICEL Corporation)

Polyglycerol compound PG-3: Polyglycerin PGL X (the number of repeating units: 40) (manufactured by DAICEL Corporation)

Comparative compound X: Decaglycerine monolaurate (Product name: POEM J-0021 manufactured by RIKEN VITAMIN CO., LTD.)

Comparative compound Y: Decaglycerin oleate (Product name: POEM J-0381V manufactured by RIKEN VITAMIN CO., LTD.)

Comparative compound Z: glycerin monocaprylate (Product name: POEM M-100 manufactured by RIKEN VITAMIN CO., LTD.)

Other components PAA: Polyacrylic acid (Product name: GLASCOL E15 manufactured by Allied Colloids Manufacturing GmbH)

Other components PVA: Vinyl alcohol/vinyl acetate copolymer (Product name: ERKOL WX48/20 manufactured by Erkol S.A.)

Surfactant: Fluorine-based surfactant (Product name: ZONYL FSO 100 manufactured by DuPont)

[Evaluation of Lithographic Printing Plate Precursor]

With respect to respective lithographic printing plate precursors, visibility, on-board developability, and printing durability are evaluated as follows. The evaluation was performed by using a lithographic printing plate precursor right after the production and lithographic printing plate precursors which were forced to be left over time according to Thermoconditions A and B as below. In addition, greasing (stain of non-image portion) was evaluated by using lithographic printing plate precursors forced to be left over time according to Thermoconditions A and B as below.

<Thermocondition A>

Produced lithographic printing plate precursors and interleaving paper (interleaving paper disclosed in Example 1 disclosed in JP2003-302749A (corresponding to EP1353221B1)) were alternately overlapped, and 50 sheets of the lithographic printing plate precursor were packaged as one case. A packaged lithographic printing plate precursor was preserved for one day at 50° C. under the environment of 50% RH.

<Thermocondition B>

Produced lithographic printing plate precursors and interleaving paper (interleaving paper disclosed in Example 1 disclosed in JP2003-302749A (corresponding to EP1353221B1)) were alternately overlapped, and 50 sheets of the lithographic printing plate precursor were packaged as one case. A packaged lithographic printing plate precursor was preserved for two days at 50° C. under the environment of 60% RH.

(Visibility)

The lithographic printing plate precursor was exposed in the conditions of external drum rotation speed of 1,000 rpm, a laser output of 70%, and a resolution of 2,400 dpi by Luxel PLATESETTER T-6000III on which an infrared ray semiconductor laser was mounted and which was manufactured by FUJIFILM Corporation. The exposure image was caused to include a solid image and a 50% halftone dot chart of a 20 μm dot FM screen.

Measurement of L*a*b* was performed respectively on a solid-black exposed portion and an unexposed portion of the image recording layer by using a spectral colorimeter CM-2500d (manufactured by Konica Minolta, Inc.) with a light source of D65 at a view angle of 10°. From the respective obtained measurement values of the solid-black exposed portion and the unexposed portion of the image recording layer, a difference ΔL* of L* values in SCE modes was calculated, and evaluation was performed according to criteria below. 4 and 3 are levels that are acceptable in practice. Results are presented in Table 2.

4: ΔL* was equal to or greater than 7 and less than 10

3: ΔL* was equal to or greater than 5 and less than 7

2: ΔL* was equal to or greater than 3 and less than 5

1: ΔL* was greater than 0 and less than 3

(On-Board Developability)

The lithographic printing plate precursor after exposure was attached to a plate cylinder of a printing machine LITHRONE26 manufactured by Komori Corporation without being subjected to a development process. Dampening water of Ecolity-2 (manufactured by Fujifilm Corporation)/tap water=2/98 (capacity ratio) and SPACE COLOR FUSION G(N) ink (manufactured by DIC Graphics Corporation) were used, and dampening water and ink were supplied in a standard automatic printing start method of LITHRONE26, on-board development was performed, and printing was performed on 100 sheets of TOKUBISHI ART (76.5 kg) paper in a printing speed of 10,000 sheets per hour.

On-board development on the printing machine of an unexposed portion of the image recording layer was completed, and a required number of sheets of printing paper until ink is not transferred to a non-image portion were evaluated as on-board developability. The results are presented in Table 2.

(Printing Durability)

After the on-board developability evaluation was performed, printing was continued. When the number of printing increased, the image recording layer was gradually worn out and thus ink density on a printed matter decreased. The number of prints when a value obtained by measuring a halftone dot area ratio of a 50% halftone dot of an FM screen on the printed matter with a GRETAG densitometer was decreased from a measured value of the 100th sheets of printing by 5% were counted and were evaluated as printing durability. The results are presented in Table 2.

(Greasing After Elapse of Time)

Printing was performed as follows by using lithographic printing plate precursors forced to be left over time according to Thermoconditions A and B as below, and density (greasing) of the non-image portion in the 500th sheet of printed matters was measured with a Gretag densitometer. Results are presented in Table 2. In addition, all greasing measured by using lithographic printing plate precursors before elapse of time (right after production) in the manner described above was less than 0.1.

TABLE 2

| | | |
|---|---|---|
| Before elapse of time | After elapse of time (Thermocondition A) | After elapse of time (Thermocondition B) |

| | | On-board | Printing | | On-board | | Printing | | On-board | | Printing |
|---|---|---|---|---|---|---|---|---|---|---|---|
| | | developability | durability | | developability | | durability | | developability | | durability |
| | Visi- | (Number of | (Number of | Visi- | (Number of | | (Number of | Visi- | (Number of | | (Number |
| | bility | sheets) | sheets) | bility | sheets) | Greasing | sheets) | bility | sheets) | Greasing | of sheets) |
| Example 1 | 4 | 5 | 61000 | 4 | 7 | <0.1 | 59000 | 4 | 10 | 0.1 | 52000 |
| Example 2 | 4 | 5 | 62000 | 4 | 8 | <0.1 | 57000 | 4 | 12 | 0.2 | 51000 |
| Example 3 | 4 | 10 | 60000 | 3 | 12 | <0.1 | 57000 | 3 | 14 | 0.2 | 50000 |
| Example 4 | 4 | 13 | 72000 | 4 | 15 | <0.1 | 70000 | 4 | 18 | <0.1 | 65000 |
| Example 5 | 4 | 5 | 83000 | 4 | 6 | <0.1 | 80000 | 4 | 7 | <0.1 | 75000 |
| Example 6 | 4 | 5 | 83000 | 4 | 7 | <0.1 | 80000 | 4 | 7 | <0.1 | 75000 |
| Example 7 | 4 | 7 | 83000 | 4 | 7 | <0.1 | 80000 | 4 | 10 | <0.1 | 75000 |
| Example 8 | 4 | 10 | 93000 | 4 | 12 | <0.1 | 90000 | 4 | 13 | <0.1 | 85000 |
| Example 9 | 4 | 5 | 93000 | 4 | 7 | <0.1 | 90000 | 3 | 10 | <0.1 | 85000 |
| Example 10 | 4 | 5 | 88000 | 4 | 7 | <0.1 | 85000 | 3 | 12 | <0.1 | 80000 |
| Comparative | 4 | 15 | 40000 | 4 | 100> | 0.6 | 36000 | 4 | 500> | 0.8 | 31000 |
| Example 1 | | | | | | | | | | | |
| Comparative | 4 | 20 | 45000 | 4 | 100> | 0.4 | 42000 | 4 | 500 > | 0.5 | 37000 |
| Example 2 | | | | | | | | | | | |
| Comparative | 4 | 15 | 37000 | 4 | 40 | 0.6 | 32000 | 4 | 50 | 0.7 | 30000 |
| Example 3 | | | | | | | | | | | |
| Comparative | 4 | 15 | 42000 | 4 | 50 | 0.6 | 37000 | 4 | 60 | 0.7 | 31000 |
| Example 4 | | | | | | | | | | | |
| Comparative | 4 | 15 | 42000 | 4 | 50 | 0.5 | 37000 | 4 | 70 | 0.8 | 31000 |
| Example 5 | | | | | | | | | | | |
| Comparative | 2 | 5 | 59000 | 1 | 8 | <0.1 | 55000 | 1 | 9 | 0.1 | 41000 |
| Example 6 | | | | | | | | | | | |

As clearly understood from the results described in Table 2 above, it is possible to obtain a thermal fusion-type lithographic printing plate precursor having excellent visibility and excellent on-board developability even if being preserved for a long period of time, by causing the infrared ray absorbing dye and the polyglycerol compound according to the invention to be contained in the image recording layer (Examples 1 to 3).

In addition, if an interlayer containing a compound having a phosphoric acid group or a phosphonic acid group is provided, printing durability is enhanced, decrease of the on-board developability and the printing durability in the case of preservation for a long period of time is prevented (Examples 4 to 10).

In contrast, if the image recording layer does not contain the polyglycerol compound (Comparative Example 1), on-board developability in the case of preservation for a long period of time is greatly deteriorated. In addition, when polyglycerol ester having a long chain alkyl group such as decaglycerine monolaurate is contained (Comparative Examples 3, 4, and 5), on-board developability in the case of preservation for a long period of time is also deteriorated.

Further, when the image recording layer does not contain a polyglycerol compound and an interlayer containing a compound having a phosphoric acid group or a phosphonic acid group is provided (Comparative Example 2), on-board developability in the case of preservation for a long period of time is greatly deteriorated.

Further, when R¹ in the infrared ray absorbing dye expressed by General Formula (I) uses an infrared ray absorbing dye for comparison which is a group other than the group expressed by General Formula (Ia) (Comparative Example 6), visibility is greatly deteriorated.

From the above, it is understood that, causing the polyglycerol compound to be contained in the image recording layer of the thermal fusion-type lithographic printing plate precursor together with the specific infrared ray absorbing dye is specifically effective on the enhancement of the on-board developability of the thermal fusion-type lithographic printing plate precursor.

### INDUSTRIAL APPLICABILITY

According to the invention, it is possible to obtain a thermal fusion-type lithographic printing plate precursor having excellent visibility and excellent on-board developability even when the lithographic printing plate precursor is preserved for a long period of time. Also, it is possible to obtain a thermal fusion-type lithographic printing plate precursor having excellent preservation stability.

The invention was described in detail with reference to specific embodiments, but it is clear to a person skilled in the art that various modifications and changes can be made without departing from the gist and the scope of the invention.

This application is based on Japanese patent application (JP2013-149862) filed on Jul. 18, 2013, and the entire contents thereof are incorporated herein by reference.

What is claimed is:

1. A lithographic printing plate precursor comprising, on a support:
an image recording layer containing
(A) a thermoplastic fine particle polymer,
(B) an infrared ray absorbing dye, and
(C) a polyglycerol compound,
wherein the infrared ray absorbing dye is an infrared ray absorbing dye expressed by the following General Formula (I), and
wherein the polyglycerol compound is a compound having three or more structural units selected from structural units expressed by the following General Formulae (1) and (2), 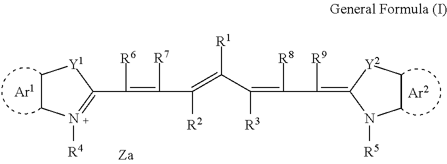
where, in General Formula (I), R¹ represents a group expressed by the following General Formula (Ia), each of R² and R³ independently represents a hydrogen atom or an alkyl group, or R² and R³ represent atomic groups that are required for forming a cyclic structure by being linked to each other, each of Ar¹ and Ar² independently represents an atomic group that is required for forming a benzene ring or a naphthalene ring, each of Y¹ and Y² independently represents an sulfur atom or a dialkyl methylene group, each of R⁴ and R⁵ independently represents an alkyl group, each of R⁶, R⁷, R⁸, and R⁹ independently represents a hydrogen atom or an alkyl group, and Za represents a counter ion that neutralizes electrical charges,
—NR¹⁰-L-X—Y General Formula (Ia)
where, in General Formula (Ia), R¹⁰ represents a hydrogen atom, an aliphatic hydrocarbon group, or a (hetero)aryl group, or an atomic group that is required for forming a cyclic structure by being linked to Y, L represents a single bond or a bivalent linking group, X represents —CO—, —SO₂—, or —SO—, Y represents —R^{11a}, —OR^{11b}, —NR¹²R¹³, or —CF₃, R^{11a} represents a hydrogen atom, an aliphatic hydrocarbon group, or a (hetero)aryl group, R^{11b} represents an aliphatic hydrocarbon group or a (hetero)aryl group, each of R¹² and R¹³ independently represents a hydrogen atom, an aliphatic hydrocarbon group, or a (hetero)aryl group, or R¹² and R¹³ represent atomic groups that are required for forming a cyclic structure by being linked to each other, and 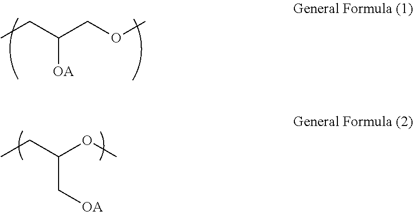
where, in General Formulae (1) and (2), A represents a hydrogen atom, an alkyl group having 1 to 4 carbon atoms, or an alkyl carbonyl group having 2 to 5 carbon atoms.

2. The lithographic printing plate precursor according to claim 1,
wherein A in the structural units expressed by General Formulae (1) and (2) is a hydrogen atom.

3. The lithographic printing plate precursor according to claim 1,
wherein, in General Formula (Ia), X is —CO—.

4. The lithographic printing plate precursor according to claim 2,
wherein, in General Formula (Ia), X is —CO—.

5. The lithographic printing plate precursor according to claim 1,
wherein, in General Formula (Ia), Y is —OR^{11b}, and said R^{11b} is an aliphatic hydrocarbon group with an a position-branched chain shape.

6. The lithographic printing plate precursor according to claim 2,
wherein, in General Formula (Ia), Y is —OR^{11b}, and said R^{11b} is an aliphatic hydrocarbon group with an a position-branched chain shape.

7. The lithographic printing plate precursor according to claim 3,
wherein, in General Formula (Ia), Y is —OR^{11b}, and said R^{11b} is an aliphatic hydrocarbon group with an a position-branched chain shape.

8. The lithographic printing plate precursor according to claim 4,
wherein, in General Formula (Ia), Y is —OR^{11b}, and said R^{11b} is an aliphatic hydrocarbon group with an α position-branched chain shape.

9. The lithographic printing plate precursor according to claim 5,
wherein said R^{11b} is a tertiary butyl group.

10. The lithographic printing plate precursor according to claim 6,
wherein said R^{11b} is a tertiary butyl group.

11. The lithographic printing plate precursor according to claim 7,
wherein said R^{11b} is a tertiary butyl group.

12. The lithographic printing plate precursor according to claim 8,
wherein said R^{11b} is a tertiary butyl group.

13. The lithographic printing plate precursor according to claim 1, further comprising:
an interlayer containing a compound having a phosphoric acid group or a phosphonic acid group between the support and the image recording layer.

14. The lithographic printing plate precursor according to claim 2, further comprising:
an interlayer containing a compound having a phosphoric acid group or a phosphonic acid group between the support and the image recording layer.

15. The lithographic printing plate precursor according to claim 13,
wherein the compound having the phosphoric acid group or the phosphonic acid group is a polymer compound.

16. The lithographic printing plate precursor according to claim 14,
wherein the compound having the phosphoric acid group or the phosphonic acid group is a polymer compound.

17. The lithographic printing plate precursor according to claim 13,
wherein the compound having the phosphoric acid group or the phosphonic acid group is a polymer compound.

18. The lithographic printing plate precursor according to claim 14,
wherein the compound having the phosphoric acid group or the phosphonic acid group is a polymer compound.

19. A method for producing a plate comprising:
image-exposing the lithographic printing plate precursor according to claim 1, with an infrared ray laser; and
removing an unexposed portion of the image recording layer by using at least one of printing ink and dampening water on a printing machine.
